(19) United States
(12) Patent Application Publication
(10) Pub. No.: US 2018/0203666 A1
(43) Pub. Date: Jul. 19, 2018

(54) FIRST-IN FIRST-OUT CONTROL CIRCUIT, STORAGE DEVICE, AND METHOD OF CONTROLLING FIRST-IN FIRST-OUT CONTROL CIRCUIT

(71) Applicant: Sony Corporation, Tokyo (JP)

(72) Inventors: Hiroyuki Okumura, Kanagawa (JP); Kosei Yamashita, Kanagawa (JP); Yoshitaka Suga, Kanagawa (JP); Hideki Takahashi, Kanagawa (JP); Nobuo Kato, Kanagawa (JP); Yuken Goto, Tokyo (JP)

(21) Appl. No.: 15/744,408

(22) PCT Filed: May 16, 2016
(86) PCT No.: PCT/JP2016/064423

§ 371 Date: Jan. 12, 2018

(30) Foreign Application Priority Data
Jul. 21, 2015 (JP) 2015-143785

(51) Int. Cl. G06F 5/14

(52) U.S. Cl. CPC G06F 5/14

(57) ABSTRACT

A FIFO memory which reads data in response to a read request from a plurality of read units is realized with a simple configuration.

When there is a data writing request to a first-in first-out data bolding unit provided with a plurality of entries in each of which data is held, a write pointer control unit writes data in the entry indicated by a write pointer out of a plurality of entries and updates the write pointer. Also, a read pointer control unit reads the data from the entry indicated by a read pointer corresponding to a read unit which requests data reading out of a plurality of read pointers associated with different read units and updates a corresponding read pointer.

### TECHNICAL FIELD

The present technology relates to a first-in first-out control circuit, a storage device, and a method of controlling a first-in first-out control circuit. In detail, this relates to a first-in first-out control circuit for outputting data in response to a read request from a plurality of read units, a storage device, and a method of controlling a first-in first-out control circuit.

### BACKGROUND ART

Conventionally, a FIFO memory which buffers data by a first-in first-out (FIFO) method is often used in a system which processes the data in input order. For example, a FIFO memory provided with a FIFO circuit capable of holding a plurality of data, a FIFO control circuit, and a random access memory (RAM) is proposed (refer to, for example, Patent Document 1).

In the FIFO memory described above, a read request is individually input from each of a plurality of read units such as central processing units (CPUs) #0 and #1. When the number of read requests from one of the CPU #0 and the CPU #1 is larger than the other, the FIFO read circuit saves data as many as a difference to the RAM.

For example, consider a case where the read requests are received from one CPU #0 three times and the read request is received only once from the other CPU #1. In this case, the FIFO control circuit takes out three data of data D0, D1, and D2 in this order from the FIFO circuit, supplies ail of the data to the CPU #0, and supplies only the data D0 to the CPU #1. Then, the FIFO control circuit saves the data D1 and D2 which are not supplied to the CPU #1 to the RAM. Thereafter, upon further receiving the read request from the CPU #1, the FIFO control circuit reads the saved data D1 and D2 and supplies them to the CPU #1. In this manner, by saving the data to the RAM, the two CPUs may independently read the data from the FIFO circuit.

### CITATION LIST

### Patent Document

### Patent Document 1: Japanese Patent Application Laid-Open No. 2012-18606

### SUMMARY OF THE INVENTION

### Problems to be Solved by the Invention

It is necessary to further provide the RAM for saving the data in addition to the FIFO circuit in the above-described conventional technology, and there is a problem that a cost and a circuit scale of the FIFO memory increase accordingly.

The present technology is achieved in view of such a situation, and an object thereof is to realize a FIFO memory which reads data according to a read request from a plurality of read units with a simple configuration.

### Solutions to Problems

The present technology is achieved to solve the above-described problems, and a first aspect thereof is a first-in first-out control circuit provided with a write pointer control unit which, when there is a data writing request to a first-in first-out data holding unit provided with a plurality of entries in each of which data is held, writes data in an entry indicated by a write pointer out of the plurality of entries and updates the write pointer, and a read pointer control unit which reads the data from the entry indicated by a read pointer corresponding to a read unit which requests data reading out of a plurality of read pointers associated with different read units and updates the corresponding read pointer, and a method of controlling the same. As a result, there is arm effect that the data is read from the entry indicated by the read pointer corresponding to the read unit which requests the data reading out of a plurality of read pointers.

Also, in the first aspect, the write pointer control unit may further write current time in the first-in first-out data holding unit together with the data each time the data writing is requested. As a result, there is an effect that the data and the current time are written.

Also, in the first aspect, the data holding unit may hold the time for each of the entries, and the read pointer control unit may further read the time corresponding to the entry indicated by the read pointer from the first-in first-out data holding unit. As a result, there is an effect that the time held for each entry is read.

Also, in the first aspect, the data holding unit may hold only latest time out of written times as the latest time, and in a case where time corresponding to the entry indicated by the read pointer is not held, the read pointer control unit may generate the corresponding time from the latest time. As a result, there is an effect that the corresponding time is generated from the latest time.

Also, in the first aspect, when data overflows from the first-in first-out data holding unit, the write pointer control unit may supply a buffer full response without writing the data. As a result, there is an effect that, when the data overflows, the buffer full response is supplied.

Also, in the first aspect, when data overflows from the first-in first-out data holding unit, the write pointer control unit may supply a buffer full response, write the data in the entry indicated by the write pointer, and update the write pointer and the read pointer. As a result, there is an effect that, when the data overflows, the data is written in the entry indicated by the write pointer.

Also, in the first aspect, a number-of-data information holding unit which holds number-of-data information indicating the number of the data which is not read by the read unit for each of the read units may be further provided, in which the write pointer control unit may determine whether data overflows from the first-in first-out data holding unit on the basis of the number-of-data information, and the read pointer control unit may determine whether there is no data which may be read. by the read unit on the basis of the number-of-data information corresponding to the read unit. As a result, there is an effect that it is determined whether the data overflows and whether there is no data which may be read on the basis of the number of data.

Also, in the first aspect, the read pointer control unit may generate the read pointer from the number-of-data information corresponding to the read unit and the write pointer. As a result, there is an effect that the read pointer is generated from the number-of-data information corresponding to the read unit and the write pointer.

Also, in the first aspect, an empty flag holding unit which holds an empty flag indicating whether there is no data which may be read by the read unit for each of the read units may be further provided, in which the write pointer control unit may determine whether data overflows from the first-in first-out data holding unit on the basis of the empty flag corresponding to the read unit, the write pointer, and the corresponding read pointer, and the read pointer control unit may determine whether there is no data which may be read by the read unit on the basis of the empty flag corresponding to the read unit. As a result, there is an effect that it is determined whether the data which may read is present on the basis of the empty flag.

Also, in the first aspect, a full flag holding unit which holds a full flag indicating whether data overflows from the first-in first-out data holding unit for each of the read units may be further provided, in which the write pointer control unit may determine whether data overflows from the first-in first-out data holding unit on the basis of the full flag corresponding to the read unit, and the read pointer control unit may determine whether there is no data which may be read by the read unit on the basis of the full flag corresponding to the read unit, the write pointer, and the corresponding read pointer. As a result, there is an effect that it is determined whether the data overflows on the basis of the full flag.

Also, in the first aspect, a threshold holding unit which holds a predetermined threshold for each of the read units may be further provided, in which, when the number of the data which is not read by the read unit becomes larger than the predetermined threshold corresponding to the read unit, the read pointer control unit may issue a request of interruption for a process on the data to the read unit. As a result, there is an effect that, when the number of data which is not read becomes larger than the predetermined threshold corresponding to the read unit, the interruption is requested for the process on the data.

Also, a second aspect of the present technology is a storage device provided with a first-in first-out data holding unit provided with a plurality of entries in each of which data is held, a write pointer control unit which, when there is a data writing request to the first-in first-out data holding unit, writes data in an entry indicated by a write pointer out of the plurality of entries and updates the write pointer, and a read pointer control unit which reads the data from the entry indicated by a read pointer corresponding to a read unit which requests data reading out of a plurality of read pointers associated with different read units and updates the corresponding read pointer. As a result, there is an effect that the data is read from the entry indicated by the read pointer corresponding to the read unit which requests the data reading out of a plurality of read pointers.

Also, in the first aspect, a status management unit which, when notification of a status of the storage device is requested, generates the status may be further provided. As a result, there is an effect that the status is generated in response to the status notification request.

### Effects of the Invention

According to the present technology, it is possible to obtain as excellent effect that the FIFO memory which reads the data in response to the read request from a plurality of read units may be realized with a simple configuration. Meanwhile, the effects are not necessarily limited to the effects herein described and may include any of the effects described in the present disclosure.

### BRIEF DESCRIPTION OF DRAWINGS

FIG. 1 is a block diagram illustrating a configuration example of an information processing apparatus in a first embodiment of the present technology.

FIG. 2 is a block diagram illustrating a configuration example of a FIFO memory in the first embodiment of the present technology.

FIG. 3 is a view illustrating a configuration example of a FIFO data holding unit in the first embodiment of the present technology.

FIG. 4 is a view illustrating an example of data held in a management information holding unit in the first embodiment of the present technology.

FIG. 5 is a view illustrating an example of operation of a write pointer control unit in the first embodiment of the present technology.

FIG. 6 is a view illustrating an example of operation of a read pointer control unit in the first embodiment of the present technology.

FIG. 7 is a flowchart illustrating an example of an enqueueing process in the first embodiment of the present technology.

FIG. 8 is a flowchart illustrating an example of a dequeueing process in the first embodiment of the present technology.

FIG. 9 is a view illustrating an example of operation of a write pointer control unit in a first variation of the first embodiment of the present technology.

FIG. 10 is a flowchart illustrating an example of an enqueueing process in the first variation of the first embodiment of the present technology.

FIG. 11 is a view illustrating an example of data held in a management information holding unit in a second variation of the first embodiment of the present technology.

FIG. 12 is a view illustrating an example of operation of a write pointer control unit in the second variation of the first embodiment of the present technology.

FIG. 13 is a view illustrating an example of operation of a read pointer control unit in the second variation of the first embodiment of the present technology.

FIG. 14 is a flowchart illustrating an example of an enqueueing process in the second variation of the first embodiment of the present technology.

FIG. 15 is a flowchart illustrating an example of a dequeueing process in the second variation of the first embodiment of the present technology.

FIG. 16 is a view illustrating an example of data held in a management information holding unit in a third variation of the first embodiment of the present technology.

FIG. 17 is a view illustrating an example of operation of a write pointer control unit in the third variation of the first embodiment of the present technology.

FIG. 18 is a view illustrating an example of operation of a read pointer control unit in the third variation of the first embodiment of the present technology.

FIG. 19 is a flowchart illustrating an example of an enqueueing process in the third variation of the first embodiment of the present technology.

FIG. 20 is a flowchart illustrating an example of a dequeueing process in the third variation of the first embodiment of the present technology.

FIG. 21 is a view illustrating an example of data held in a management information holding unit in a fourth variation of the first embodiment of the present technology.

FIG. 22 is a view illustrating an example of operation of a read pointer control unit in the fourth variation of the first embodiment of the present technology.

FIG. 23 is a flowchart illustrating an example of a dequeueing process in the fourth variation of the first embodiment of the present technology.

FIG. 24 is a block diagram illustrating a configuration example of a FIFO control circuit in a fifth variation of the first embodiment of the present technology.

FIG. 25 is a view illustrating an example of data held in a management information holding unit in the fifth variation of the first embodiment of the present technology.

FIG. 26 is a block diagram illustrating a configuration example of a FIFO control circuit in a sixth variation of the first embodiment of the present technology.

FIG. 27 is a block diagram illustrating a configuration example of an information processing apparatus according to a seventh variation of the first embodiment of the present technology.

FIG. 28 is a block diagram illustrating a configuration example of a FIFO memory in an eighth variation of the first embodiment of the present technology.

FIG. 29 is a block diagram illustrating a configuration example of an information processing apparatus in a second embodiment of the present technology.

FIG. 30 is a view illustrating a configuration example of a FIFO data holding unit in the second embodiment of the present technology.

FIG. 31 is a view illustrating an example of operation of a write pointer control unit in the second embodiment of the present technology.

FIG. 32 is a view illustrating an example of operation of a read pointer control unit in the second embodiment of the present technology.

FIG. 33 is a flowchart illustrating an example of operation of the information processing apparatus in the second embodiment of the present technology.

FIG. 34 is a view illustrating a configuration example of a FIFO data holding unit in a variation of the second embodiment of the present technology.

FIG. 35 is a view illustrating an example of operation of a read pointer control unit in the variation of the second embodiment of the present technology.

FIG. 36 is a flowchart illustrating an example of a dequeueing process in the variation of the second embodiment of the present technology.

### MODE FOR CARRYING OUT THE INVENTION

A mode for carrying out the present technology (hereinafter, referred to as an embodiment) is hereinafter described. The description is given in the following order.

1. First Embodiment (Example of Holding Read Pointer for Each Data Processing Unit)

2. Second. Embodiment (Example of Holding Read Pointer for Each Data Processing Unit and Holding Data and Time Information)

### 1. First Embodiment

### [Configuration Example of Information Processing Apparatus]

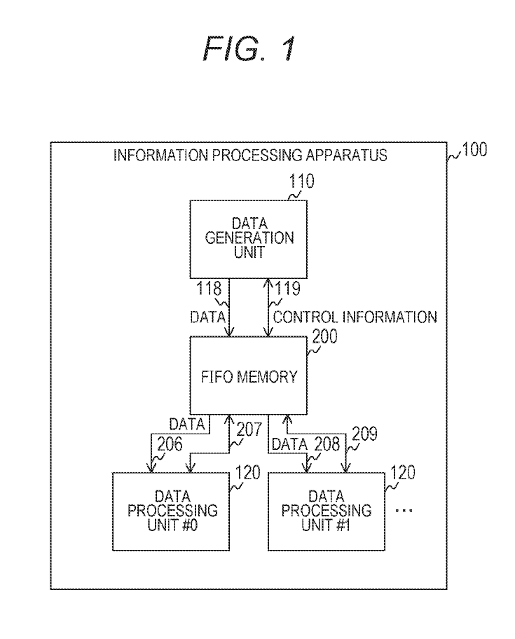

FIG. 1 is a block diagram illustrating a configuration example of an information processing apparatus 100 in a first embodiment of the present technology. The information processing apparatus 100 is provided with a data generation unit 110, a FIFO memory 200, and a plurality of data processing units 120.

The data generation unit 110 generates data and writes the same in the FIFO memory 200. For example, various circuits such as an acceleration sensor, an image sensor, and a communication module are assumed as the data generation unit 110. Also, the data generation unit 110 exchanges control information with the FIFO memory 200.

The control information includes, for example, an initialization request, a write request, a read request, and a response. The initialization request requests initialization of the FIFO memory 200. The write request is a data writing request to the FIFO memory 200. The read request is a data reading request to the FIFO memory 200. The response is the response from the FIFO memory 200 to the write request and the read request and includes a notification such as buffer full and buffer empty.

Also, the initialization request is supplied by the data generation unit 110 or the data processing unit 120. The write request is supplied together with the data to be written by the data generation unit 110. The read request is supplied by the data processing unit 120.

The FIFO memory 200 holds a plurality of data by a first-in first-out method. The FIFO memory 200 is used as a buffer for compensating differences in processing speed and transfer speed between the data generation unit 110 and the data processing unit 120. Meanwhile, the FIFO memory 200 is an example of a storage device recited in claims.

The data processing unit 120 reads the data from the FIFO memory 200 to process. Each of a plurality of data processing units 120 (such as a data processing unit #0 and a data processing unit #1) may independently supply the read request to the FIFO memory 200 to read the data. As the data processing unit 120, for example, a CPU is assumed. Meanwhile, the data processing unit 120 is an example of a read unit recited in claims.

[Configuration Example of FIFO Memory]

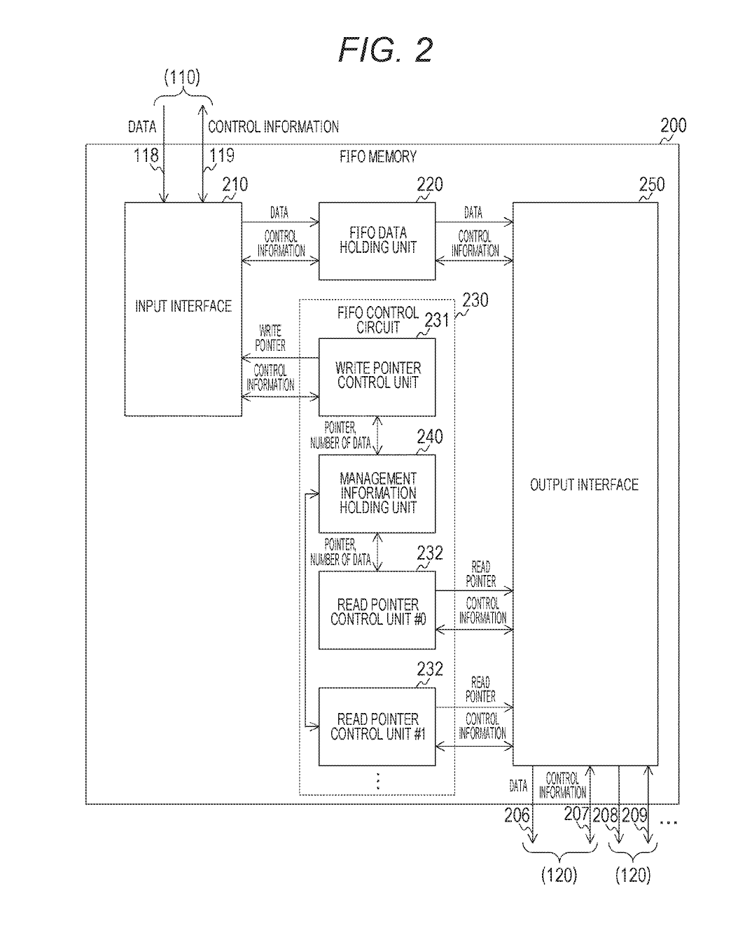

FIG. 2 is a block diagram illustrating a configuration example of the FIFO memory 200 in the first embodiment of the present technology. The FIFO memory 200 is provided with an input interface 210, a FIFO data holding unit 220, a FIFO control circuit 230, and an output interface 250. Also, the FIFO control circuit 230 is provided with a write pointer control unit 231, a plurality of read pointer control units 232 (such as a read pointer control unit #0 and a read pointer control unit #1), and a management information holding unit 240. Meanwhile, the FIFO control circuit 230 is an example of a first-in first-out control circuit recited in claims.

Herein, the read pointer control unit 232 is provided for each read port being a communication channel for the data processing unit 120 to read the data. Different data processing units 120 are allocated to the respective read ports. That is, the different data processing units 120 are associated with the respective read pointer control units 232. For example, the read pointer control unit #0 is associated with the data processing unit #0, and the read pointer control unit #1 is associated with the data processing unit #1.

The input interface 210 transmits and receives the data and the control information between the data generation unit 110 and the FIFO data holding unit 220 and FIFO control circuit 230.

The FIFO data holding unit 220 holds a plurality of data. A plurality of entries is provided in the FIFO data holding unit 220, and the data is held in each of the entries. Meanwhile, the FIFO data holding unit 220 is an example of a first-in first-out data holding unit recited in claims.

The management information holding unit 240 holds management information for managing the FIFO data holding unit 220. For example, as the management information, a write pointer, a read pointer, and number-of-data information are held. The write pointer indicates the entry for writing the data in the FIFO data holding unit 220. Also, the read pointer and the number-of-data information are provided for each data processing unit 120. The read pointer indicates the entry for the corresponding data processing unit 120 to read the data. The number-of-data information indicates the number of data which is not read by the corresponding data processing unit 120 (in other words, the number of data being buffered which may be read) out of the data held in the FIFO data holding unit 220.

The write pointer control unit 231 writes the data in the entry indicated by the write pointer in accordance with the write request to update the write pointer. When the initialization request is supplied, the write pointer control unit 231 sets all of the number-of-data information and the write pointer to initial values (for example, “0”).

Also, when the write request is supplied, the write pointer control unit 231 determines whether a buffer is full for the FIFO data holding unit 220. For example, the write pointer control unit 231 refers to the number-of-data information of the management information holding unit 240 and determines that the buffer is full in a case where any number of data is equal to the total number of entries (hereinafter referred to as a “buffer size”). In a case where the buffer is full, the write pointer control unit 231 discards the data from the data generation unit 110 and returns a buffer full response to the data generation unit 110.

On the other hand, in a case where the buffer not full, the write pointer control unit 231 obtains the write pointer from the management information holding unit 240 to write the data in the entry indicated by the write pointer. For example, the write pointer control unit 231 controls a driver (not illustrated) to write the data in the entry indicated by the write pointer. Also, the write pointer control unit 231 updates (for example, increments) the write pointer by incrementing, decrementing, or the like, and increments (for example, increments) all of the numbers of data.

The read pointer control unit 232 reads the data from the entry indicated by the read pointer in accordance with the read request to update the read pointer. When the initialization request is supplied, the read pointer control unit 232 sets the read pointer to an initial value.

Also, when the read request is supplied from the corresponding data processing unit 120, the read pointer control unit 232 determines whether it is in a state in which there is no data which may be read by the data processing unit 120 (that is, buffer is empty). For example, the read pointer control unit 232 reads the number-of-data information corresponding to the data processing unit 120 related to the read request from the management information holding unit 240 and determines that the buffer is empty in a case where the number-of-data information is at the initial value. In a case where the buffer is empty, the read pointer control unit 232 returns a buffer empty response to the data processing unit 120 related to the read request.

On the other hand, in a case where the buffer is not empty, the read pointer control unit 232 obtains the corresponding read pointer from the management information holding unit 240 and reads the data from the entry indicated by the read pointer. For example, the read pointer control unit 232 controls a driver (not illustrated) to read the data from the entry indicated by the read pointer. Also, the read pointer control unit 232 updates (for example, increments) the corresponding read pointer by incrementing, decrementing, or the like, and decrements (for example, decrements) the corresponding number of data.

The output interface 250 transmits and receives the data and the control information between the data processing unit 120 and the FIFO data holding unit 220 and FIFO control circuit 230.

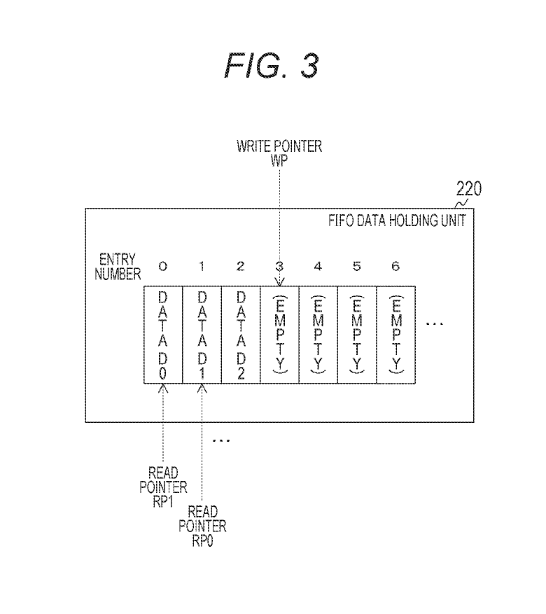

FIG. 3 is a view illustrating a configuration example of the FIFO data holding unit 220 in the first embodiment of the present technology. In the drawing, each of rectangular figures to which an entry number is allocated indicates the entry. As illustrated in the drawing, a plurality of entries is provided in the FIFO data holding unit. Herein, the entry number is a number for identifying the entry, and this entry number is set for the write pointer and the read pointer.

When the initialization request is supplied, the FIFO control circuit 230 initializes a write pointer WP and a plurality of read pointers such as read pointers RP0 and RP1, for example, to “0”. That is, each pointer in an initial state indicates the entry with an entry number “0”. Also, the FIFO control circuit 230 initializes the number-of-data information N0 and N1 to “0”. Herein, the read pointer RP0 and the number-of-data information NO are associated with the data processing unit #0, and the read pointer RP1 and the number-of-data information N1 are associated with the data processing unit #1.

When the write request for requesting the writing of data D0 is supplied by the data generation unit 110 after the initialization, the FIFO control circuit 230 writes the data D0 in the entry with the entry number “0” indicated by the write pointer. Also, the FIFO control circuit 230 updates the write pointer to “1” and updates both the number-of-data information N0 and N1 to “1”. Similarly, when the write request of data D1 and the write request of data D2 are sequentially supplied, the FIFO control circuit 230 sequentially writes the data in the entries with the entry numbers “1” and “2” indicated by the write pointer. Also, the write pointer is updated to “2” and then updated to “3”. Both the number-of-data information N0 and N1 are updated to “2” and then updated to “3”.

Then, when the read request is supplied only by the data processing unit #0, the FIFO control circuit 230 reads the data D0 from the entry with the entry number “0” indicated by the corresponding read pointer RP0 and supplies the same to the data processing unit #0. Also, the FIFO control circuit 230 updates the read pointer RP0 to “1” and updates the corresponding number-of-data information N0 to “2”. On the other hand, since there is no read request from the data processing unit #1 at that time, the corresponding read pointer RP1 and number-of-data information N1 remain at initial values.

Also, when updating the write pointer and the read pointer, if these pointers are of the last entry numbers, the FIFO control circuit 230 updates the pointer to the first entry number. The buffer having a circular structure a head and a tail of which are connected in this manner is referred to as a ring buffer.

As described above, since the FIFO control circuit 230 individually controls the read pointer for each of the data processing units #0 and #1, there is no need of providing a RAM and the like for saving the data on the FIFO control circuit 230. Therefore, it is possible to realize the FIFO control circuit 230 which reads the data in response to the read requests from a plurality of data processing units 120 with a simple configuration.

Meanwhile, although the FIFO control circuit 230 initializes each of the pointers to the entry number “0”, it is also possible to initialize the same to a number other than “0”. Also, although the FIFO control circuit 230 increments each of the pointers for each access, it is also possible to decrement instead of incrementing. Also, although the FIFO control circuit 230 updates the last entry number to the first entry number such that the FIFO memory 200 becomes the ring buffer, the configuration is not limited to this as long as the FIFO may be realized. For example, each time the data is read from the entry of the read pointer having the largest number of data, the FIFO control circuit 230 may control to update all the pointers while padding all the data one by one in a direction in which the entry number decreases.

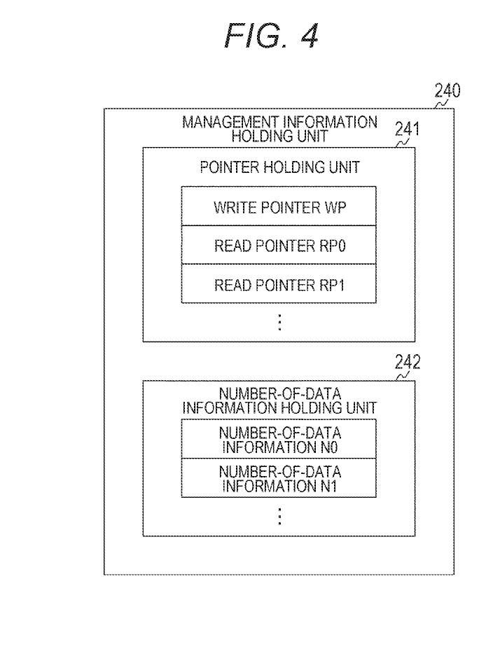

FIG. 4 is a view illustrating an example of the data held in the management information holding unit 240 in the first embodiment of the present technology. The management information holding unit 240 is provided with a pointer holding unit 241 and a number-of-data information holding unit 242. The pointer holding unit 241 holds the write pointer WP and the read pointers (such as RP0 and RP1) corresponding to a plurality of data processing units 120, respectively. The number-of-data information holding unit 242 holds the number-of-data information (such as number-of-data information N0 and N1) corresponding to a plurality of data processing units 120, respectively.

[Operation Example of Write Pointer Control Unit]

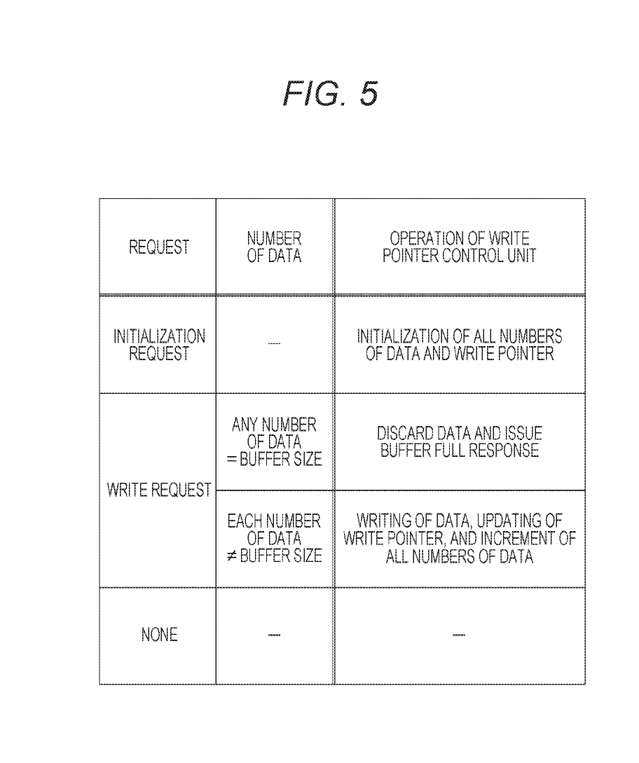

FIG. 5 is a view illustrating an example of operation of the write pointer control unit 231 in the first embodiment of the present technology. When the initialization request is supplied, the write pointer control unit 231 initializes all of the number-of-data information and the write pointer.

Also, in a case where the write request is supplied and any number of data is equal to the buffer size (that is, the buffer is full), the write pointer control unit 231 discards the data and returns the buffer full response to the data generation unit 110. On the other hand, in a case where the buffer is not full, the write pointer control unit 231 writes the data in the entry indicated by the write pointer and updates the write pointer. When updating, if the number indicated by the write pointer is the last entry number, the write pointer is updated to the first entry number. Also, the FIFE) control circuit 230 increments all the numbers of data.

[Operation Example of Read Pointer Control Unit]

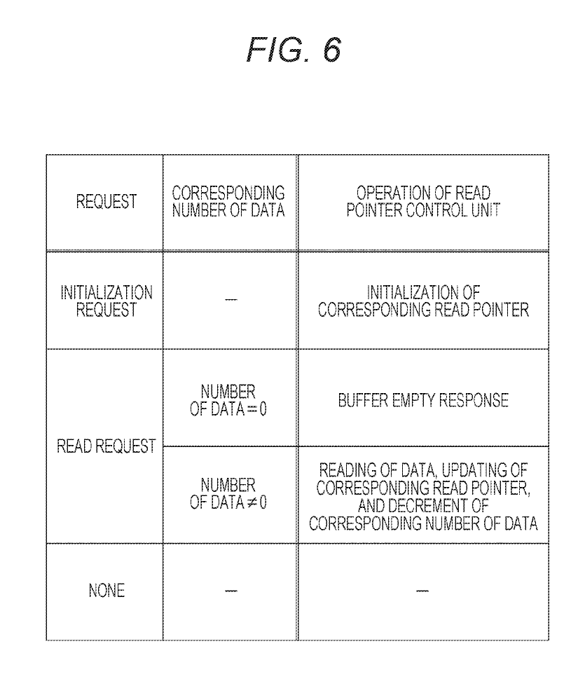

FIG. 6 is a view illustrating an example of operation of the read pointer control unit 232 in the first embodiment of the present technology.

When the initialization request is supplied, the read pointer control unit 232 initializes the read pointer.

Also, in a case where the read request is supplied and the corresponding number of data is “0” (that is, the buffer is empty), the read pointer control unit 232 returns the buffer empty response to the corresponding data processing unit 120. On the other hand, in a case where the buffer is not empty, the read pointer control unit 232 reads the data from the entry indicated by the read pointer and updates the read pointer. When updating, if the number indicated by the read pointer is the last entry number, the read pointer is updated to the first entry number. Also, the FIFO control circuit 230 decrements the corresponding number of data.

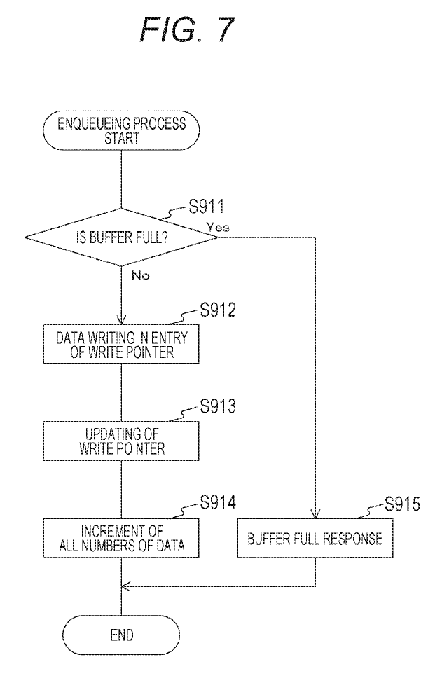

FIG. 7 is a flowchart illustrating an example of an enqueueing process in the first embodiment of the present technology. This enqueueing process is executed according to the write request.

The write pointer control unit 231 determines whether the buffer is full on the basis of the number-of-data information (step S911). In a case where the buffer is not full (step S911: No), the write pointer control unit 231 writes the data in the entry indicated by the write pointer (step S912) and updates the write pointer (step S913). Also, the write pointer control unit 231 increments ail the numbers of data (step S914).

On the other hand, in a case where the buffer is full (step S911: Yes), the write pointer control unit 231 returns the buffer full response to the data generation unit 110 (step S915). After step S914 or S915, the write pointer control unit 231 ends the enqueueing process.

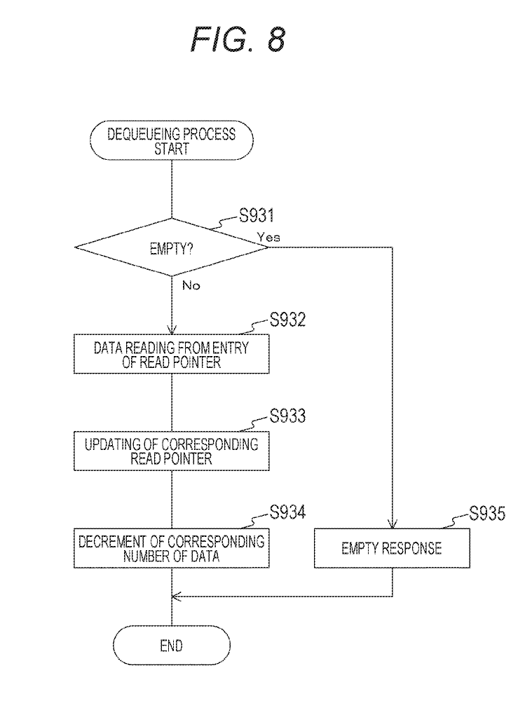

FIG. 8 is a flowchart illustrating an example of a dequeueing process in the first embodiment of the present technology. This dequeueing process is executed in response to the read request.

The read pointer control unit 232 determines whether the buffer is empty on the basis of the corresponding number-of-data information (step S931). In a case where the buffer is not empty (step S931: No), the read pointer control unit 232 reads the data from the entry indicated by the corresponding read pointer (step S932), and updates the read pointer (step S933). Also, the read pointer control unit 232 decrements the corresponding number of data (step S934).

On the other hand, in a case where the buffer empty (step S931: Yes), the read pointer control unit 232 returns the buffer empty response to the data processing unit 120 related to the read request (step S935). After step S934 or S935, the read pointer control unit 232 ends the dequeueing process.

As described above, according to the first embodiment of the present technology, since the FIFO control circuit 230 updates the read pointers associated with the different data processing units, it is possible to read the data according to the read requests from a plurality of data processing units without using the RAM.

[First Variation]

Although the FIFO control circuit 230 discards the data related to the write request when the buffer (9190 data holding unit 220) overflows in the first embodiment described above, it is also possible to write the data without discarding the same. A FIFO control circuit 230 in a first variation of the first embodiment is different from that of the first embodiment in that data relating to a write request is written when a buffer is full.

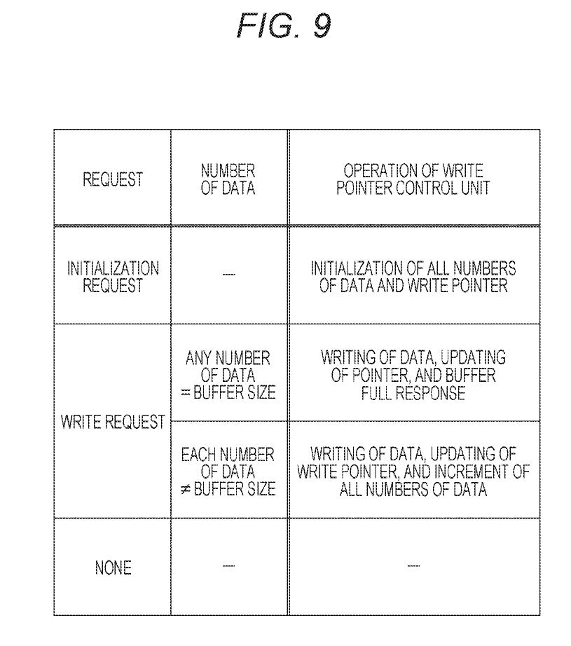

FIG. 9 is a view illustrating an example of operation of a write pointer control unit 231 in the first variation of the first embodiment of the present technology.

In a case where the write request is supplied and the buffer is full, the write pointer control unit 231 of the first variation writes the data in an entry indicated by a write pointer. Also, the write pointer control unit 231 updates a read pointer indicating the same entry as the write pointer together with the write pointer. For example, in a case where both a write pointer WP and a read pointer RP0 are “1”, both the pointers are updated to “2”. Also, the write pointer control unit 231 returns a buffer full response to the data generation unit 110. By this control, older data is discarded and newer data is preferentially written. Meanwhile, operation of the write pointer control unit 231 of the first variation in a case where the buffer is not full and in a case of an initialization request is similar to that in the first embodiment.

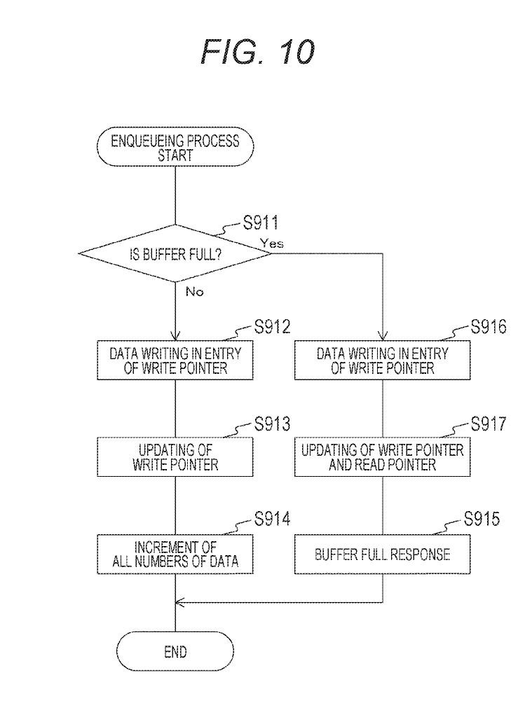

FIG. 10 is a flowchart illustrating an example of an enqueueing process in the first variation of the first embodiment of the present technology. The enqueueing process or the first variation is different from that of the first embodiment in that steps S916 and S917 are further executed.

In a case where the buffer is full (step S911: Yes), the write pointer control unit 231 writes the data in the entry indicated by the write pointer (step S916). Also, the write pointer control unit 231 updates the read pointer indicating the same entry as the write pointer together with the write pointer (step S917) and executes step S915.

In this manner, according to the first variation of the first embodiment of the present technology, the FIFO control circuit 230 writes the data and updates the pointer in a case where the FIFO data holding unit 220 overflows, so that this may perform buffering without discarding the data related to the write request.

[Second Variation]

In the first embodiment described above, the FIFO control circuit 230 holds the number-of-data information for each data processing unit 120, and determines the buffer empty state and buffer full state from the number-of-data information. However, as the number of the data processing units 120 increases, the number of held pieces of number-of-data information increases, and a capacity of the management information holding unit 240 might increase. A FIFO control circuit 230 in a second variation of the first embodiment is different from that of the first embodiment in that a capacity of a management information holding unit 240 is reduced.

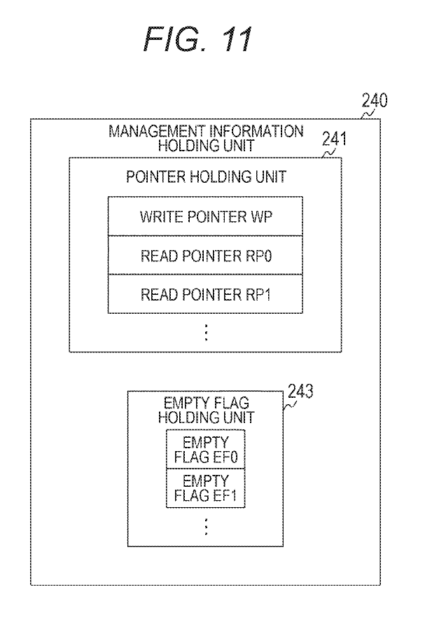

FIG. 11 is a view illustrating an example of data held in the management information holding unit 240 in the second variation of the first embodiment of the present technology. The management information holding unit 240 of the second variation is different from that of the first embodiment in that an empty flag holding unit 243 is provided in place of a number-of-data information holding unit 242.

The empty flag holding unit 243 holds an empty flag in association with each of a plurality of data processing units 120. The empty flag indicates whether a buffer is empty as seen from a corresponding data processing unit 120. For example, the empty flag is set to “1” in a case where the buffer is empty, and this is set to “0” in other cases.

In the first embodiment in which the number-of-data information is held, it is necessary to hold at least 2-bit number-of-data information for each data processing unit 120. For example, in a case where there are only two entries, the number of data held in them is any one of 0, 1, and 2, so that 2-bit number-of-data information is required. On the other hand, in the second variation, it is sufficient to hold a 1-bit empty flag for each data processing unit 120. Therefore, the capacity of the management information holding unit 240 may be reduced.

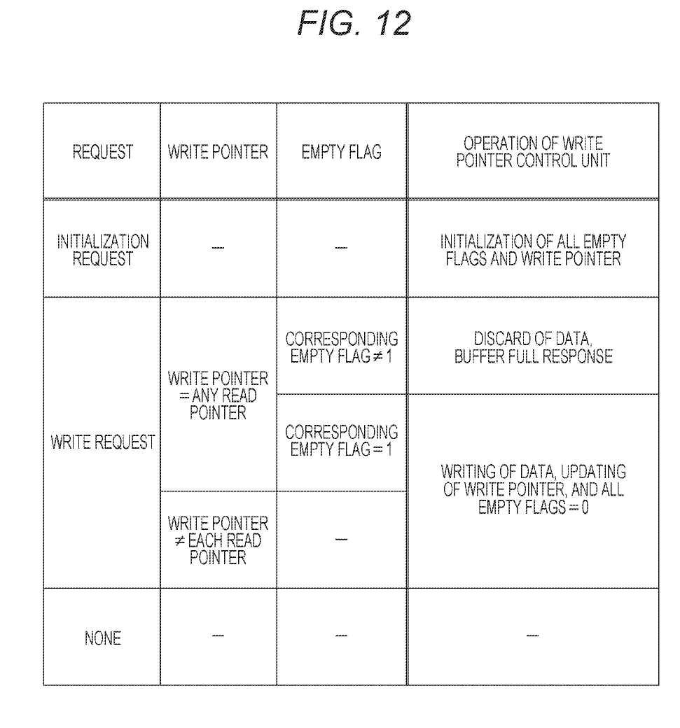

FIG. 12 is a view illustrating an example of operation of a write pointer control unit 231 in the second variation of the first embodiment of the present technology. When an initialization request is supplied, the write pointer control unit 231 of the second variation initializes all empty flags and a write pointer.

Also, when the write request is supplied, the write pointer control unit 231 of the second variation determines whether a condition that the write pointer coincides with any read pointer and the empty flag corresponding to the coincident read pointer is “0” is satisfied. When this condition is satisfied, the write pointer control unit 231 determines that the buffer is full and in a case where this is not satisfied, this determines that the buffer is not full.

The operation of the write pointer control unit 231 of the second variation in a case where the buffer is full is similar to that in the first embodiment. On the other hand, in a case where the buffer is not full, the write pointer control unit 231 writes the data and updates the write pointer, and sets ail the empty flags to “0”.

Meanwhile, when the buffer overflows in the second variation, the write pointer control unit 231 may perform the control similar to that of the first variation.

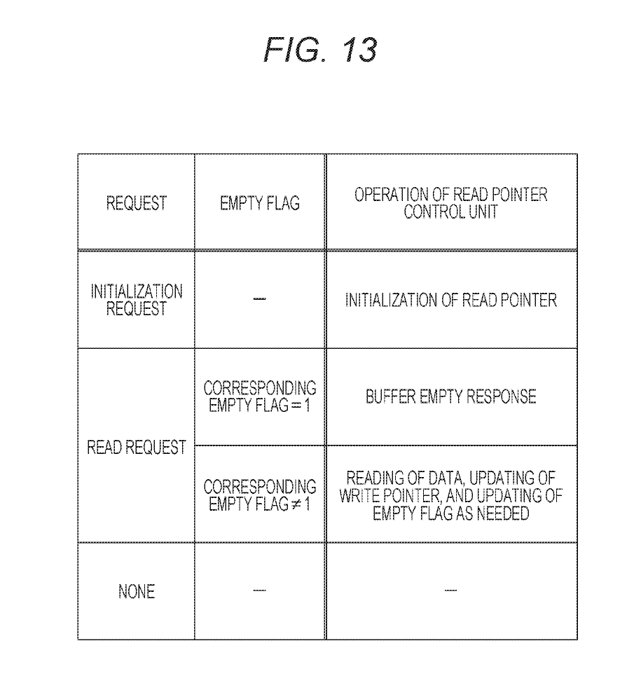

FIG. 13 is a view illustrating an example of operation of a read pointer control unit 232 in the second variation of the first embodiment of the present technology. The operation of the read pointer control unit 232 of the second variation at the time of initialization request is similar to that of the first embodiment.

When the read request is supplied, the read pointer control unit 232 of the second variation determines whether the buffer is empty depending on whether the corresponding empty flag is “1”.

The operation of the read pointer control unit 232 of the second variation in a case where the buffer is empty is similar to that of the first embodiment. On the other hand, in a case where the buffer is not empty, the read pointer control unit 232 reads the data and updates a corresponding read pointer, and determines whether the write pointer and the corresponding read pointer coincide with each other. If they coincide with each other, the read pointer control unit 232 updates the corresponding empty flag to “1”.

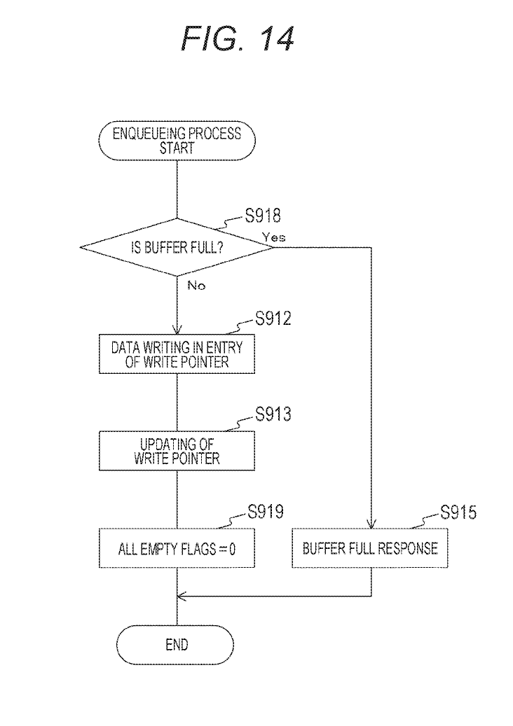

FIG. 14 is a flowchart illustrating an example of an enqueueing process in the second variation of the first embodiment of the present technology. The enqueueing process in the second variation is different from that of the first embodiment in that steps S918 and S919 are executed in place of steps S911 and S914.

The write pointer control unit 231 of the second variation determines whether a condition that the write pointer coincides with any read pointer and the empty flag corresponding to the coincident read pointer is “0”. When this condition is satisfied, the write pointer control unit 231 determines that the buffer is full and in a case where this is not satisfied, this determines that the buffer is not full (step S918).

Also, after updating the write pointer (step S913), the write pointer control unit 231 sets all the empty flags to “0” (step S919).

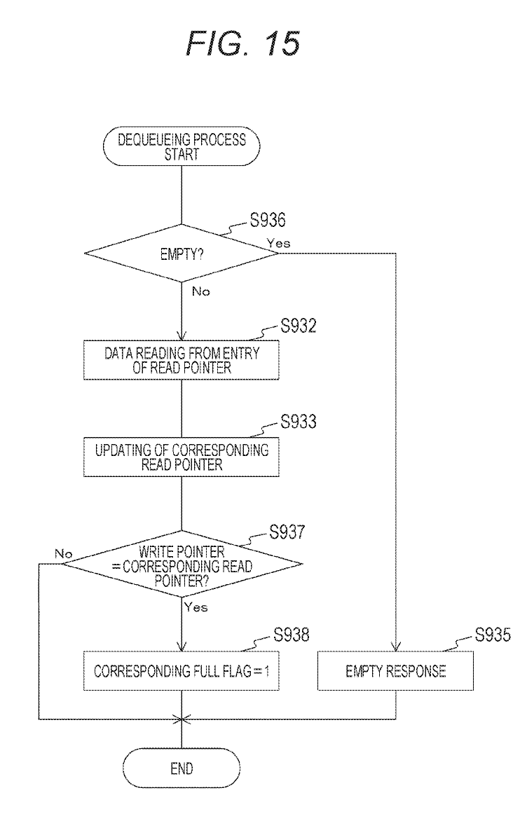

FIG. 15 is a flowchart illustrating an example of a dequeueing process in the second variation of the first embodiment of the present technology. The enqueueing process in the second variation is different from that of the first embodiment in that steps S936, S937, and S938 are executed in place of steps S931 and S934.

The read pointer control unit 232 of the second variation determines whether the buffer is empty depending on whether the corresponding empty flag is “1” (step S936).

Also, after updating the corresponding read pointer (step S933), the read pointer control unit 232 determines whether the write pointer coincides with the corresponding read pointer (step S937). In a case where they coincide with each other (step S937: Yes), the read pointer control unit 232 updates the corresponding empty flag to “1” (step S938). On the other hand, in a case where they do not coincide with each other (step S937: No) or after step S938, the read pointer control unit 232 ends the dequeueing process.

In this manner, according to the second variation of the first embodiment of the present technology, since the FIFO control circuit 230 holds the empty flag for each data processing unit, the capacity of the management information holding unit 240 may be reduced as compared to a configuration in which the number-of-data information is held for each data processing unit.

[Third Variation]

In the first embodiment described above, the FIFO control circuit 230 holds the number-of-data information for each data processing unit 120 and determines the buffer empty state and buffer full state from the number-of-data information. However, as the number of the data processing units 120 increases, the capacity of the management information holding unit 240 might increase. A FIFO control circuit 230 in a third variation of the first embodiment is different from that of the first embodiment in that a capacity of a management information holding unit 240 is reduced.

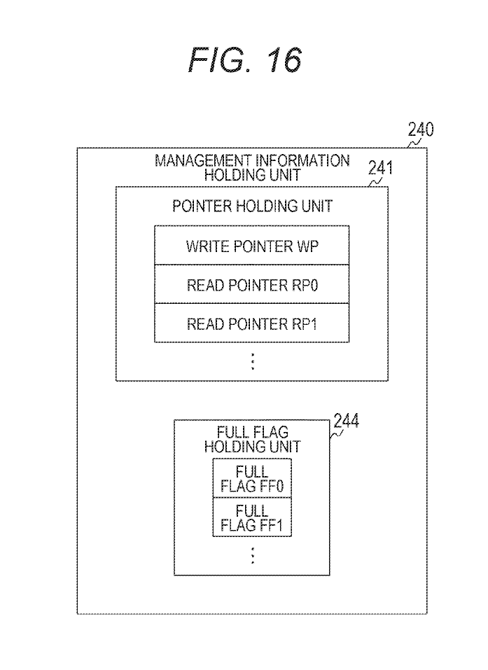

FIG. 16 is a view illustrating an example of data held in the management information holding unit 240 in the third variation of the first embodiment of the present technology. The management information holding unit 240 of the third variation is different from that of the first embodiment in that a full flag holding unit 244 is provided in place of a number-of-data holding unit 242.

The full flag holding unit 244 holds a full flag in association with each of a plurality of data processing units 120. The full flag indicates whether a buffer is full as seen from a corresponding data processing unit 120. For example, the full flag is set to “1” in a case where the buffer is full, and this is set to “0” in other cases.

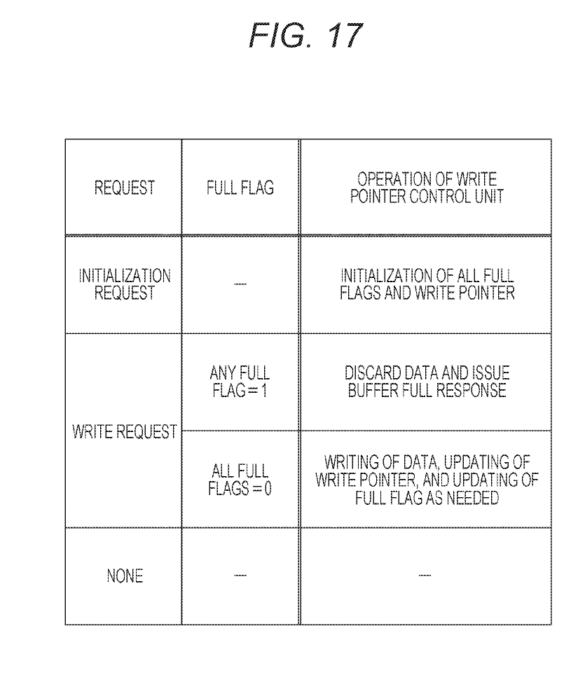

FIG. 17 is a view illustrating an example of operation of a write pointer control unit 231 in the third variation of the first embodiment of the present technology. When an initialization request is supplied, the write pointer control unit 231 initializes all the full flags and a write pointer.

Also, when a write request is supplied, the write pointer control unit 231 of the third variation determines whether the buffer is full depending on whether any full flag is set to “1”. The operation of the write pointer control unit 231 of the second variation in a case where the buffer is full is similar to that in the first embodiment. On the other hand, in a case where the buffer is not full, the write pointer control unit 231 writes the data and updates the write pointer, and determines whether the write pointer and any read pointer coincide with each other. When they coincide with each other, the write pointer control unit 231 updates the full flag corresponding to the coincident read pointer to “1”.

Meanwhile, in the third variation, when the buffer overflows, the write pointer control unit 231 may perform the control similar to that in the first variation.

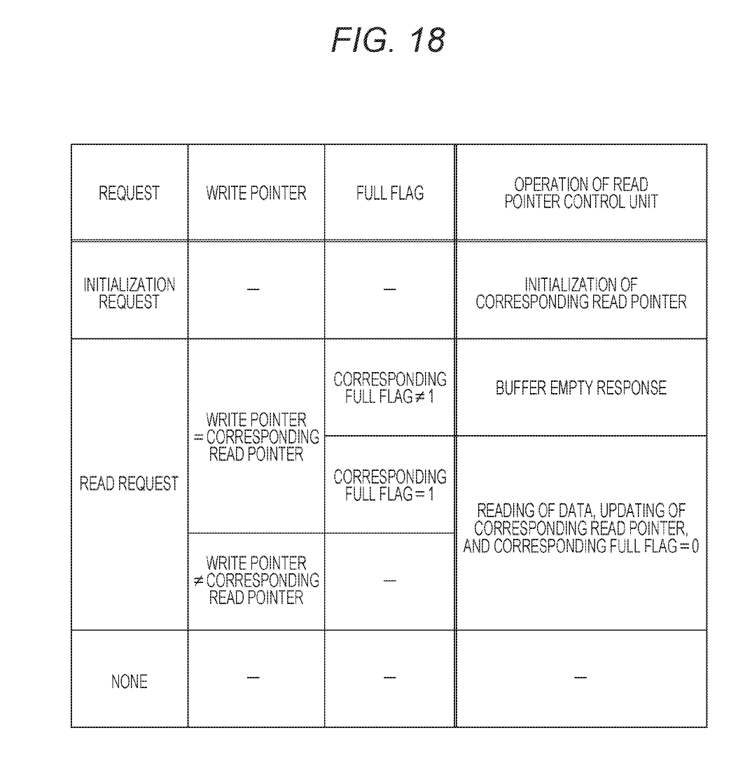

FIG. 18 is a view illustrating an example of operation of a read pointer control unit 232 in the third variation of the first embodiment of the present technology. The operation of the read pointer control unit 232 of the third variation at the time of initialization request is similar to that in the first embodiment.

Also, when the read request is supplied, the read pointer control unit 232 of the third variation determines whether a condition that the write pointer coincides with a corresponding read pointer and the corresponding full flag is “0” is satisfied. When this condition is satisfied, the read pointer control unit 232 determines that the buffer is empty and determines that the buffer is not empty in a case where this is not satisfied.

The operation of the read pointer control unit 232 of the third variation in a case where the buffer empty is similar to that in the first embodiment. On the other hand, in a case where the buffer is not empty, the read pointer control unit 232 reads the data and updates the read pointer and sets the corresponding full flag to “0”.

Meanwhile, in the third variation, the FIFO memory 200 may hold the full flag in addition to the empty flag for each data processing unit 120 and may determine whether the buffer is full on the basis of the full flag.

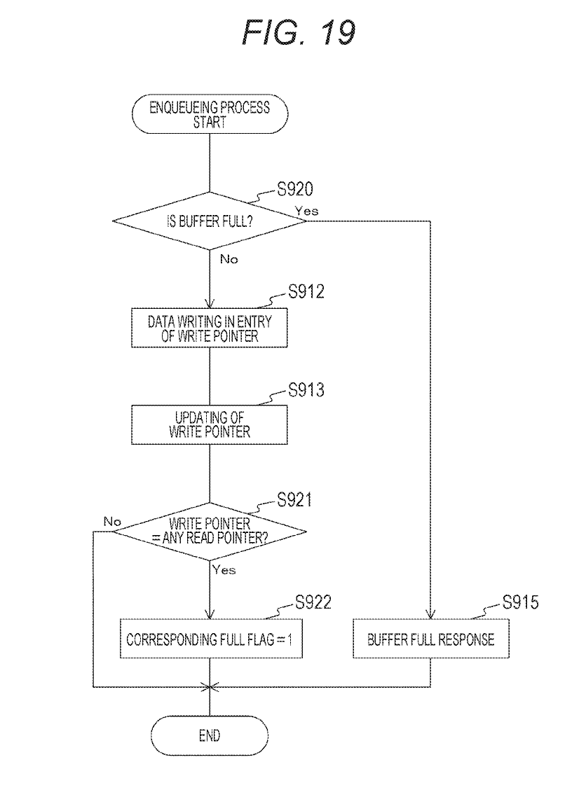

FIG. 19 is a flowchart illustrating an example of an enqueueing process in the third variation of the first embodiment of the present technology. The enqueueing process in the third variation is different from that of the first embodiment in that steps S920, S921, and S922 are executed in place of steps S911 and S914.

The write pointer control unit 231 of the third variation determines whether the buffer is full depending on whether any full flag is “1” (step S920).

Also, after updating the write pointer (step S913), the write pointer control unit 231 determines whether the write pointer coincides with any of the read pointers (step S921). In a case where any of them coincides (step S921. Yes), the write pointer control unit 231 updates the full flag corresponding to the coincident read pointer to “1” (step S922). On the other hand, in a case where none of them is coincident (step S921: No) or after step S922, the write pointer control unit 231 ends the enqueueing process.

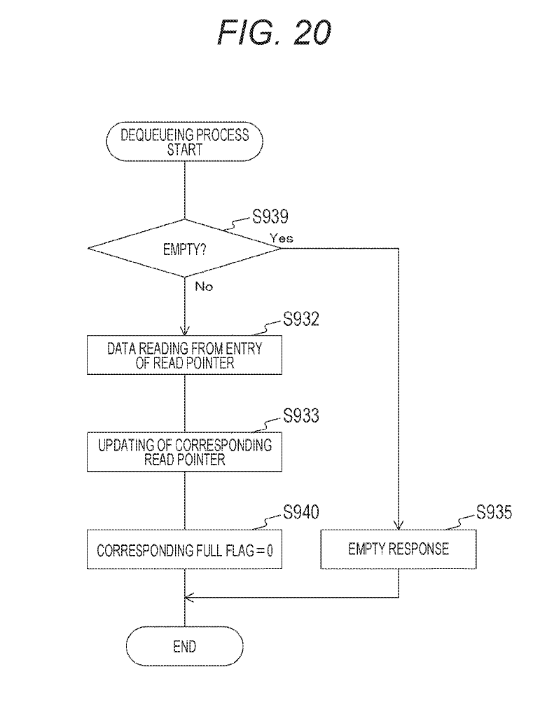

FIG. 20 is a flowchart illustrating an example of a dequeueing process in the third variation or the first embodiment of the present technology. The dequeueing process in the third variation is different from that of the first embodiment in that steps S939 and S940 are executed in place of steps S931 and S934.

The read pointer control unit 232 of the third variation determines whether a condition that the write pointer coincides with the corresponding read pointer and the corresponding full flag is “0” is satisfied. When this condition is satisfied, the read pointer control unit 232 determines that the buffer is empty and determines that the buffer is not empty in a case where this is not satisfied (step S939).

Also, after updating the read pointer (step S933), the read pointer control unit 232 sets the corresponding full flag to “0” (step S940).

In this manner, according to the third variation of the first embodiment of the present technology, since the FIFO control circuit 230 holds the full flag for each data processing unit, the capacity of the management information holding unit 240 may be reduced as compared to a configuration in which the number-of-data information is held for each data processing unit.

[Fourth Variation]

Although the FIFO control circuit 230 holds the read pointer for each data processing unit 120 in the management information holding unit 240 in the first embodiment described above, as the number of the data processing units 120 increases, the capacity of the management information holding unit 240 increases. A FIFO control circuit 230 in a fourth variation of the first embodiment is different from that of the first embodiment in that a capacity of a management information holding unit 240 is reduced.

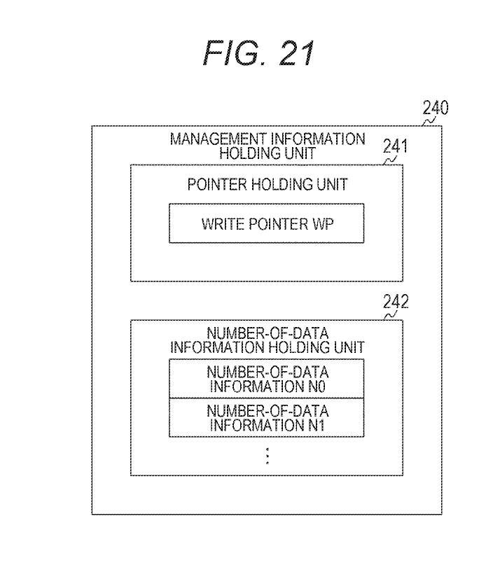

FIG. 21 is a view illustrating an example of data held in the management information holding unit 240 in the fourth variation of the first embodiment of the present technology. The management information holding unit 240 of the fourth variation is different from that of the first embodiment in that only a write pointer is held in a pointer holding unit 241 and a read pointer is not held.

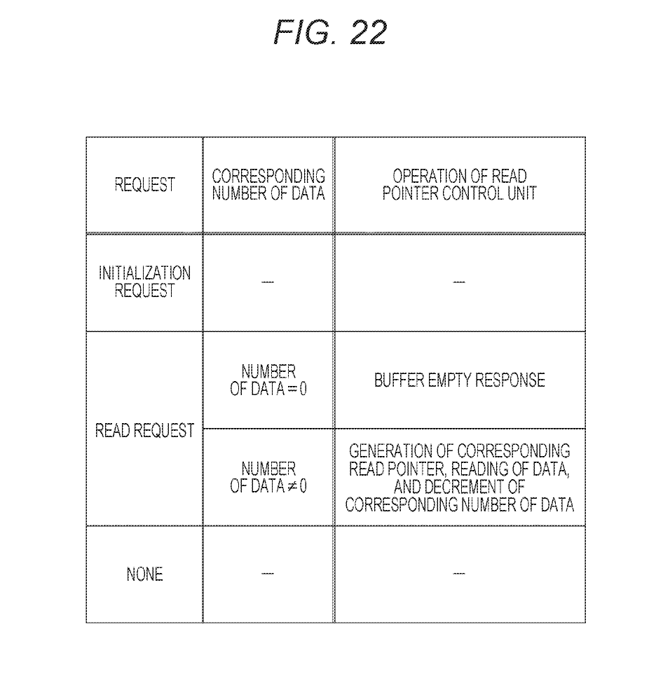

FIG. 22 is a view illustrating an example of operation of a read pointer control unit 232 in the fourth variation of the first embodiment of the present technology. In a case where a read request is suppled and a buffer is not empty, the read pointer control unit 232 generates a corresponding read pointer from corresponding number of data and the write pointer. For example, in a case where the write pointer is updated by incrementing, a value obtained by subtracting the corresponding number of data from the write pointer is an entry number indicated by the read pointer. Then, the read pointer control unit 232 reads the data from an entry indicated by the generated read pointer and decrements the number of data. As a result, the corresponding read pointer is updated.

Also, the operation of the read pointer control unit 232 when the buffer is empty in the fourth variation is similar to that in the first embodiment. Also, in the fourth variation, the read pointer control unit 232 is not required to initialize the read pointer at the time of an initialization request. Meanwhile, when the buffer overflows in the fourth variation, the write pointer control unit 231 may perform the control similar to that in the first variation.

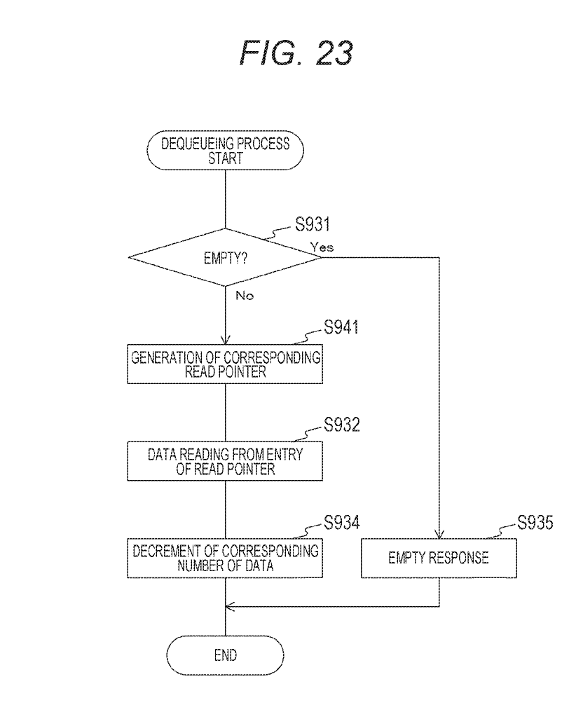

FIG. 23 is a flowchart illustrating an example of a dequeueing process in the fourth variation of the first embodiment of the present technology. The dequeueing process of the fourth variation is different from that of the first embodiment in that step S941 is executed in place of step S933.

In a case where the buffer is not empty (step S931: No), the read pointer control unit 232 generates the corresponding read pointer from the corresponding number of data and the write pointer (step S941). Then, the read pointer control unit 232 reads the data from the entry indicated by the read pointer (step S932) and decrements the number of data (step S934).

In this manner, according to the fourth variation of the first embodiment of the present technology, the FIFO control circuit 230 generates the read pointer from the write pointer each time the read request is issued without holding the read pointer, so that the capacity of the management information holding unit 240 may be reduced.

[Fifth Variation]

Although the FIFO control circuit 230 notifies the data processing unit 120 of only the buffer empty in the first embodiment described above, this may notify the data processing unit 120 of other information. For example, when the number of readable data becomes larger than a threshold, the FIFO control circuit 230 may notify the data processing unit 120 of a request of an interruption for a process on the data. The data processing unit 120 which is noted of the interruption may execute a process on the data read from the FIFO memory 200 by interrupting another process, so that overflow of the data from the FIFO memory 200 may be inhibited. A FIFO control circuit 230 of a fifth variation of the first embodiment is different from that of the first embodiment in that interruption is requested when the number of readable data becomes larger than a threshold.

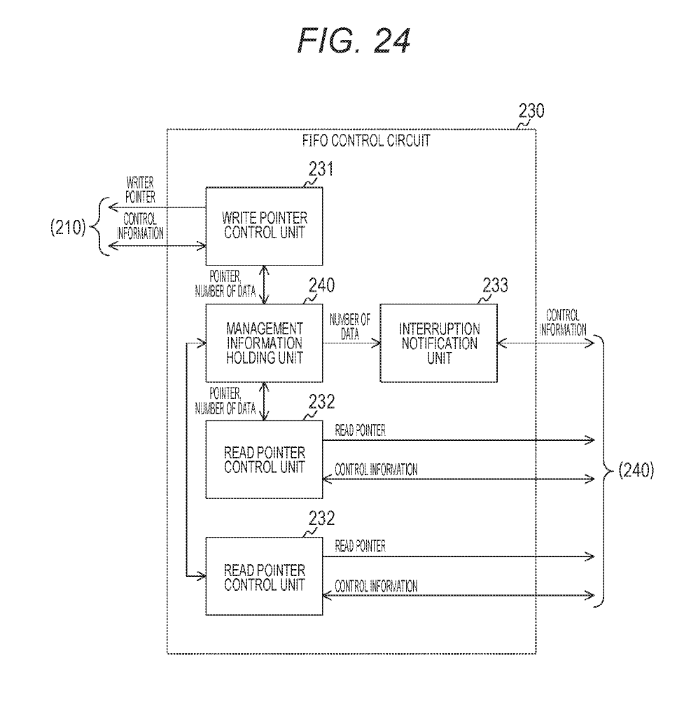

FIG. 24 is a block diagram illustrating a configuration example of the FIFO control circuit 230 in the fifth variation of the first embodiment of the present technology. The FIFO control circuit 230 of the fifth variation is different from that of the first embodiment in that an interruption notification unit 233 is further provided.

When the number of readable data becomes larger than the threshold, the interruption notification unit 233 supplies interruption notification requesting the interruption for the process on the data read from the FIFO memory 200 to a data processing unit 120. The threshold to be compared with the number of data is held in advance in the management information holding unit 240 in association with each of a plurality of data processing units 120. The thresholds are set by a data generation unit 110, a data processing unit 120 and the like. The interruption notification unit 233 compares each number of data with a corresponding threshold and supplies the interruption notification to the data processing unit 120 corresponding to the number of data when any number of data becomes larger than the corresponding threshold.

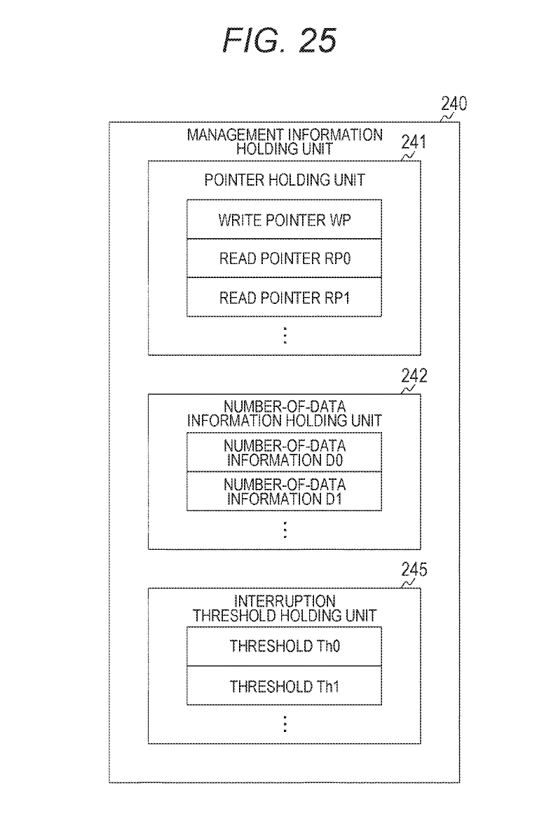

FIG. 25 is a view illustrating an example of the data held in the management information holding unit 240 in the fifth variation of the first embodiment of the present technology. The management information holding unit 240 of the fourth variation is different from that of the first embodiment in further including an interruption threshold holding unit 245.

The interruption threshold holding unit 245 holds the threshold to be compared with the number of data in association with each of a plurality of data processing units 120. The interruption notification is supplied when any number of data becomes larger than the corresponding threshold.

As described above, according to the fifth variation of the first embodiment of the present technology, the FIFO control circuit 230 requests the interruption when the number of readable data becomes larger than the threshold, so that overflow of the data from the FIFO memory 200 may be inhibited.

[Sixth Variation]

In the fifth variation of the first embodiment described above, the data generation unit 110 and the data processing unit 120 cannot refer to a status such as the number of readable data by the FIFO memory 200. However, if it is configured such that the FIFO memory 200 generates the status and notifies the data generation unit 110 and the data processing unit 120 of the status, the data generation unit 110 and the like may refer to the status. A FIFO memory 200 of a sixth variation of the first embodiment is different from that of the fifth variation in notifying of the status.

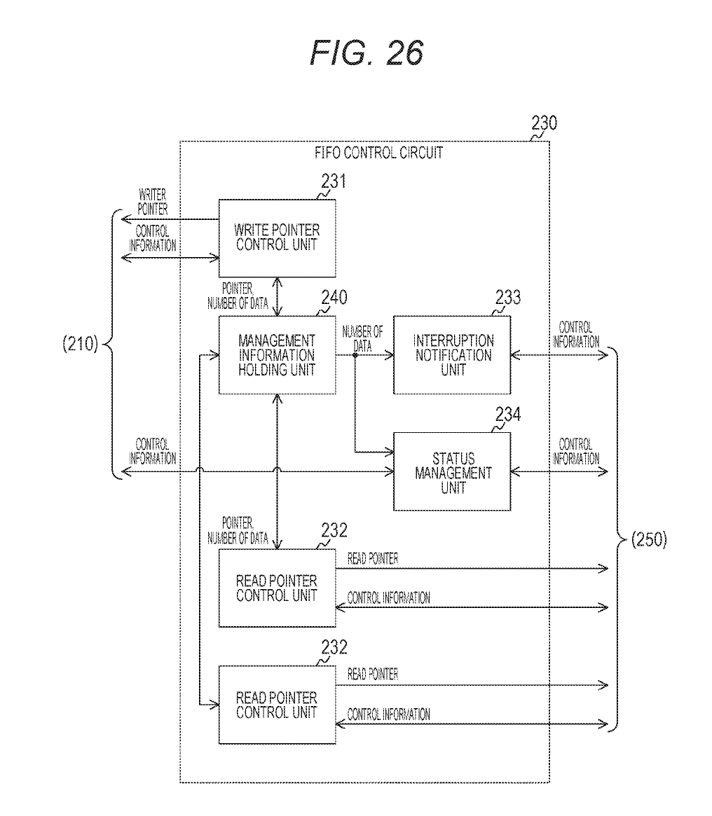

FIG. 26 is a block diagram illustrating a configuration example of a FIFO control circuit 230 in the sixth variation of the first embodiment of the present technology. The FIFO control circuit 230 of the sixth variation is different from that of the fifth variation in further including a status management unit 234.

The status management unit 234 generates the status of the FIFO memory 200 and notifies a data generation unit 110 or a data processing unit 120 of the status. Herein, the data generation unit 110 and the data processing unit 120 of the fifth variation may request the notification of the status. In response to the request, the status management unit 234 generates the status and notifies a request source of this. For example, the status includes at least one of number-of-data information, an empty flag, a full flag, a buffer underrun flag, a buffer overflow flag, and an interruption flag for each of a plurality of data processing units 120 herein, the buffer underrun flag indicates whether a read request is issued in a buffer empty state. Also, the buffer overflow flag indicates whether a write request is issued in a buffer full state. The interruption flag indicates whether interruption notification is supplied. The flags are generated for each read port (data processing unit 120).

As described above, according to the sixth variation of the first embodiment of the present technology, since the FIFO control circuit 230 notifies of the status, the data generation unit 110 and the data processing unit 120 may refer to the status and appropriately process the data.

[Seventh Variation]

Although each of a plurality of data processing units 120 and the FIFO memory 200 are connected by a signal line in the above-described first embodiment, as the number of the data processing units 120 increases, wiring of the signal lines might become complicated. An information processing apparatus 100 in a seventh variation of the first embodiment is different from that of the first embodiment in that wring is simplified.

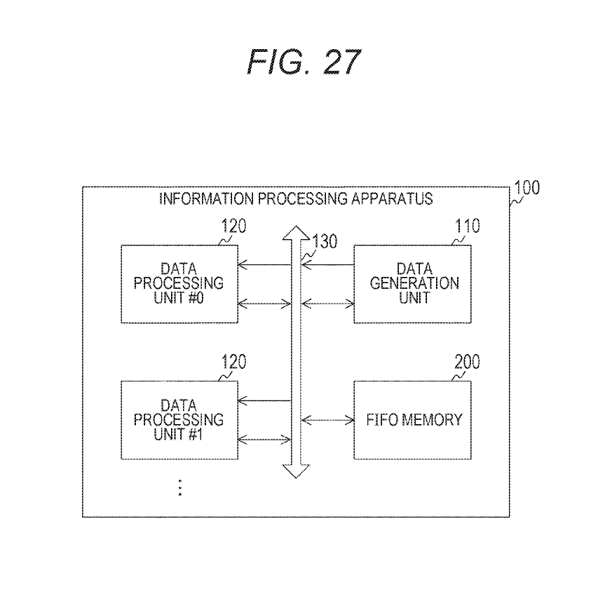

FIG. 27 is a block diagram illustrating a configuration example of the information processing apparatus 100 in the seventh variation of the first embodiment of the present technology. The information processing apparatus 100 of the seventh variation is different from that of the first embodiment in further including a bus 130.

The bus 130 is a common path through which a plurality of data processing units 120, the data generation unit 110, and the FIFO memory 200 exchange data and control information. Each of the data processing unit 120, the data generation unit 110, and the FIFO memory 200 is connected to the bus 130.

As described above, according to the seventh variation of the first embodiment of the present technology, since a plurality of data processing units 120 is connected to a FIFO memory 200 via the bus 130, the wiring may be simplified as compared to a configuration in which each of the data processing units 120 is connected by the signal line.

[Eighth Variation]

Although the FIFO control circuit 230 inputs and outputs the data via the input interface 210 and the output interface 250 in the first embodiment described above, it is also possible to integrate the interfaces into one input/output interface. A FIFO control circuit 230 of an eighth variation of the first embodiment is different from that of the first embodiment in that data is input/output through one input/output interface.

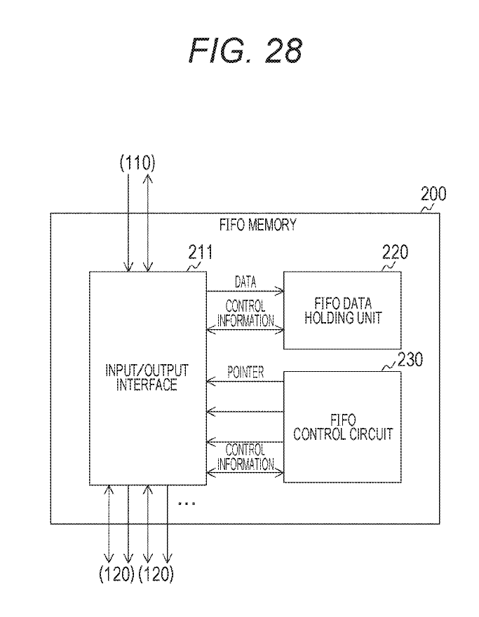

FIG. 28 is a block diagram illustrating a configuration example of a FIFO memory 200 in the eighth variation of the first embodiment of the present technology. The FIFO memory 200 of the seventh variation is different from that of the first embodiment in that an input/output interface 211 is provided in place of an input interface 210 and an output interface 250.

The input/output interface 211 exchanges data and control information between a data generation unit 110 and a data processing unit 120, and a FIFO data holding unit 220 and FIFO control circuit 230.

As described above, according to the eighth variation of the first embodiment of the present technology, since the input/output interface 211 is provided in the 5150 memory 200, the FIFO control circuit 230 may input/output the data through the input/output interface 211.

### Second Embodiment

Although the FIFO memory 200 does not hold time at which the data is generated in the second embodiment described above, there also is a case where the time is required when processing the data. For example, when the data processing unit 120 synchronizes acceleration data with global positioning system (GPS) data, it is necessary to obtain the time at which the data are generated. A FIFO memory 200 of a second embodiment is different from that of the first embodiment in further holding time at which data is generated.

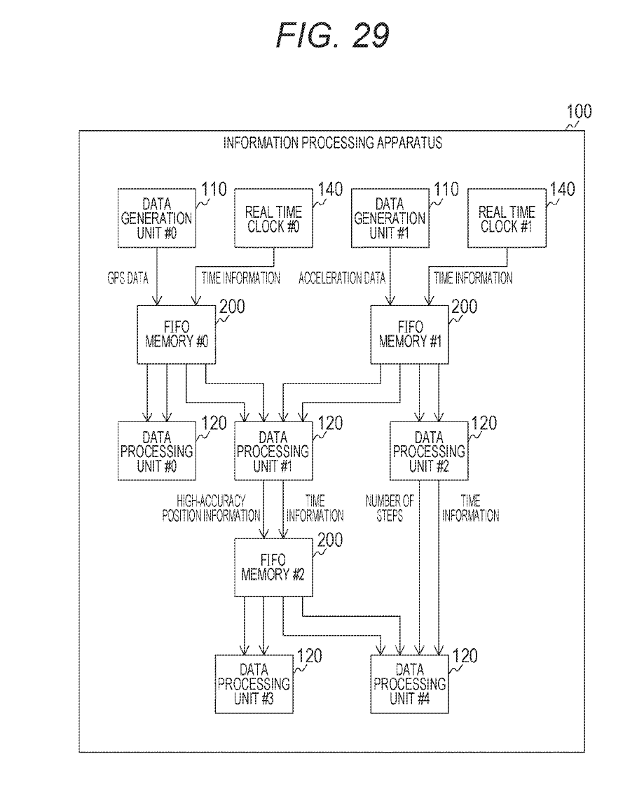

FIG. 29 is a block diagram illustrating a configuration example of an information processing apparatus 100 in the second embodiment of the present technology. The information processing apparatus 100 of the second embodiment is different from that of the first embodiment in that a real time clock 140 is provided.

The real time clock 140 generates time information indicating current time. Also, in the second embodiment, data generation units #0 and #1 are provided as data generation units 110, and real time clocks #0 and #1 are provided as the real time clocks 140. Further, FIFO memories #0, #1, and #2 are provided as the FIFO memories 200, and data processing units #0, #1, #2, #3, and #4 are provided as data processing units 120.

The data generation unit #0 is, for example, a GPS module, and each time this receives the data from a GPS satellite, this supplies the data as the GPS data to the FIFO memory #0 together with a write request.

In response to the write request, the FIFO memory #0 holds the GPS data and the time information generated by the real time clock #0.

The data processing unit #0 reads the GPS data and the time information from the FIFO memory #0 and processes them. The data processing unit #0 performs, for example, a process of creating a history of the GSP data for each time.

The data generation unit #1 is, for example, an acceleration sensor, and each time this measures acceleration, this supplies acceleration data indicating a measured value to the FIFO memory #1 together with the write request.

In response to the write request, the FIFO memory #1 holds the GPS data and the time information generated by the real time clock #1.

The data processing unit #1 synchronizes the GSP data with the acceleration data and processes them. For example, in a case where reception sensitivity of the GPS data is higher than a certain value, the data processing unit #1 generates position information from the GPS data. On the other hand, in a case where the reception sensitivity is equal to or lower than the certain value, the data processing unit #1 generates the position information on the basis of the latest GPS data received with high sensitivity and the acceleration data from reception time of the GPS data to the current time. In this manner, by interpolating the GPS data with the acceleration data, highly accurate position information may be obtained. The data processing unit #1 writes the generated position information in the FIFO memory #2 as high-accuracy position information together with the time information.

The data processing unit #2 reads the acceleration data and the time information from the FIFO memory #1 and processes them. The data processing unit #1, for example, analyzes the acceleration data for each time and counts the number of steps of a user carrying the information processing apparatus 100. The data processing unit #1 generates the number of steps for each piece of time information, and supplies the number of steps and the time information to the data processing unit #4.

The data processing unit #3 reads the high-accuracy position information and the time information from the FIFO memory #2 and processes them. For example, the data processing unit #3 performs a process of displaying a position indicated by each high-accuracy position information on a map, a process of creating a history of the high-accuracy position information and the like.

The data processing unit #4 reads the high-accuracy position information and the time information from the FIFO memory #2 and processes them, the number of steps, and the time information. For example, the data processing unit #4 performs a process of associating the high-accuracy position information with the number of steps by the time information and displaying the number of steps for each position indicated by the high-accuracy position information on a map, a process of creating the history of the high-accuracy position information and the number of steps and the like.

Meanwhile, although two data generation units 110 and two real time clocks 140, three FIFO Memories 200, and five data processing units 120 are provided in the information processing apparatus 100, the number of them. may be appropriately changed depending on a function to be realized.

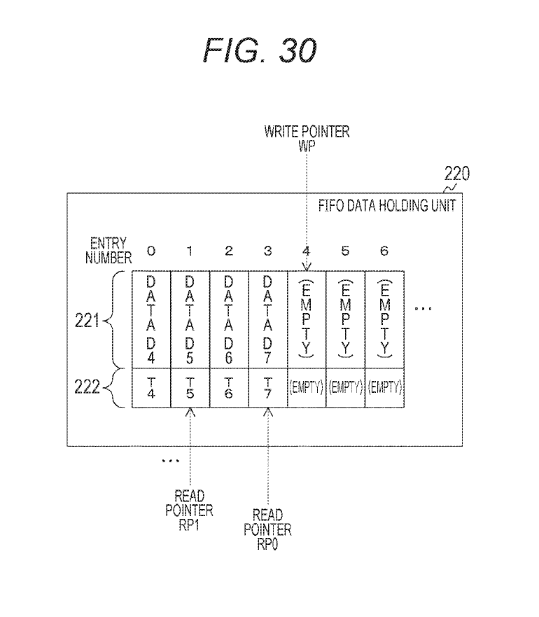

FIG. 30 is a view illustrating a configuration example of a FIFO data holding unit 220 in the second embodiment of the present technology. The FIFO data holding unit 220 of the second embodiment is provided with a buffer data holding area 221 and a time information holding area 222.

A plurality of entries is provided in the buffer data holding area 221, and data is held in each of them. The time information holding area 222 is an area in which the time information is held for each entry.

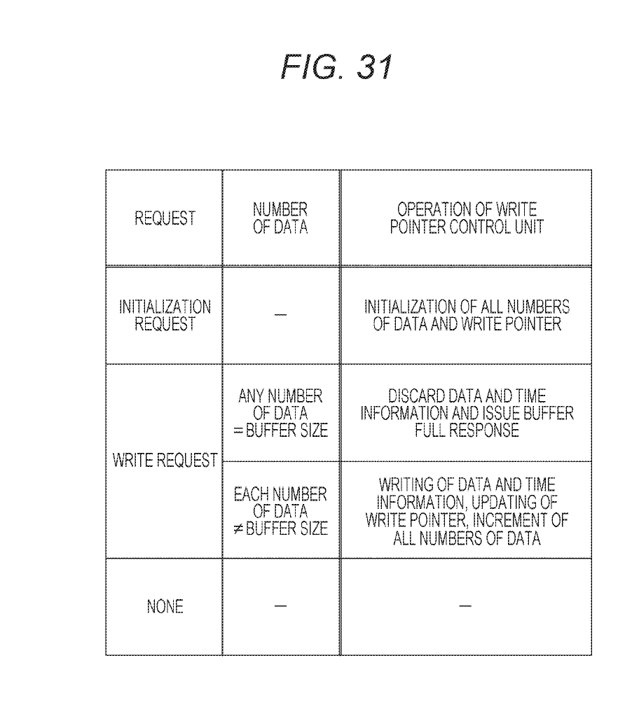

FIG. 31 is a view illustrating an example of operation of a write pointer control unit 231 in the second embodiment of the present technology. The operation of the write pointer control unit 231 of the second embodiment is similar to that of the first embodiment except that the data is written together with the time information.

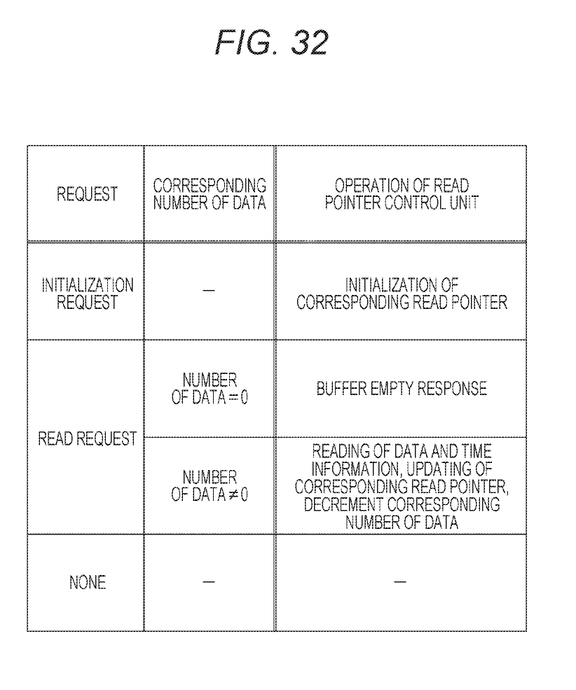

FIG. 32 is a view illustrating an example of operation of a read pointer control unit 232 in the second embodiment of the present technology. The operation of the read pointer control unit 232 of the second embodiment is similar to that of the first embodiment except that the data is read together with the time information.

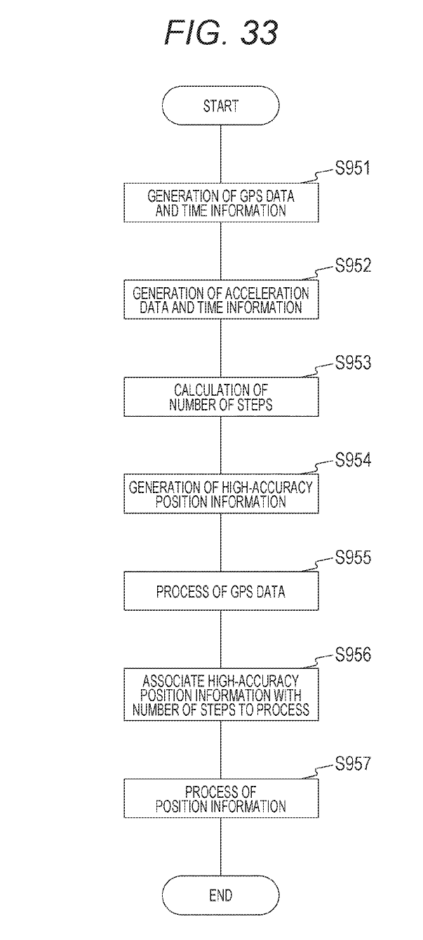

FIG. 33 is a flowchart illustrating an example of operation of the information processing apparatus 100 in the second embodiment of the present technology. This operation starts, for example, when a predetermined application is executed.

The information processing apparatus 100 generates the GPS data and the time information (step S951), and on the other hand generates the acceleration data and the time information (step S952). Then, the information processing apparatus 100 calculates the number of steps from the acceleration data (step S953), and generates the high-accuracy position information from the GPS data and the acceleration data (step S954). The information processing apparatus 100 also processes the GPS data (step S955), and associates the high-accuracy position information with the number of steps by the time information to process (step S956). Also, the information processing apparatus 100 processes the high-accuracy position information (step S957).

As described above, according to the second embodiment of the present technology, since the FIFO memory 200 holds the data together with the time information, the information processing apparatus 100 may associate a plurality of types of data with the time information and process them.

[Variation]

Although the FIFO memory 200 holds the time information for each entry in the above-described second embodiment, as the number of entries increases, the memory capacity required for holding the time information increases. A FIFO memory 200 of a variation of the second embodiment is different from that of the second embodiment in that a memory capacity is reduced.

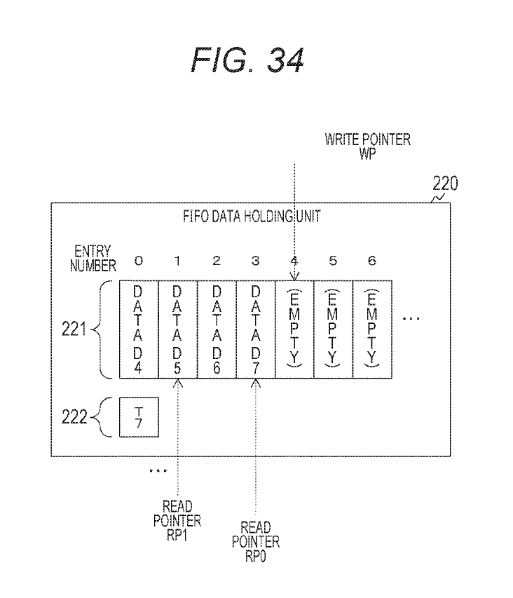

FIG. 34 is a view illustrating a configuration example of a FIFO data holding unit 220 in the variation of the second embodiment of the present technology. The FIFO data holding unit 220 is different, from that of the second embodiment, in that only the latest time information is held in a time information holding area 222. Since the latest data is written in an entry immediately before the entry indicated by a write pointer, only the time information corresponding to this data is held. This latest time information is updated each time the data is written. For example, when writing data D6 and time information T6 in the entry indicated by the write pointer, the write pointer control unit 231 holds the time information 16 in the time information holding area 222. Next, when writing data D7 and time information T7, the write pointer control unit 231 updates the time information in the time information holding area 222 to T7.

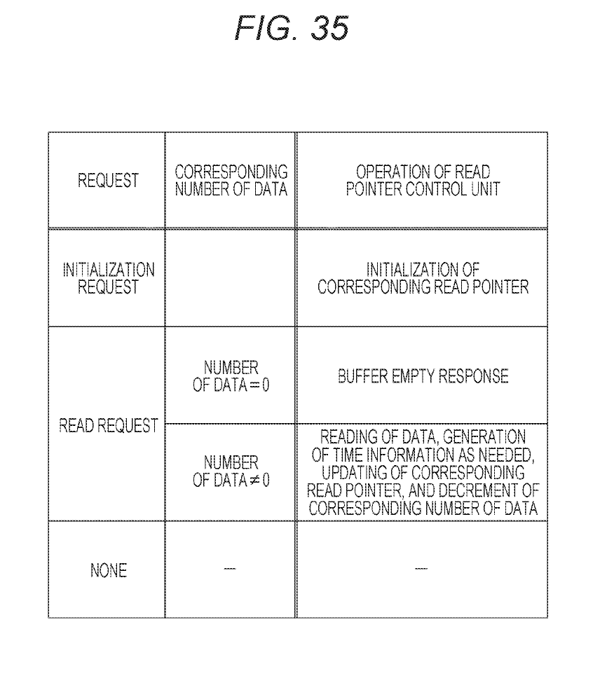

FIG. 35 is a view illustrating an example of operation of a read pointer control unit 232 in the variation of the second embodiment of the present technology. The read pointer control unit 232 of the second embodiment is different from that of the first embodiment in generating the time information as necessary. As described above, only the latest time information is held in the time information holding area 222. Therefore, in a case where the time information corresponding to the entry indicated by a read pointer is not the latest one, the read pointer control unit 232 generates the corresponding time information from the latest time information. If a period in which the data generation unit 110 generates the data is P, the number of readable data is N, and the time indicated by the latest time information is Tc, time Tr indicated by the corresponding time information is obtained by following equation 1. Units of the time Tc, time Tr, and period P is, for example, a second.

Tr=Tc−P×(N−1) Equation 1

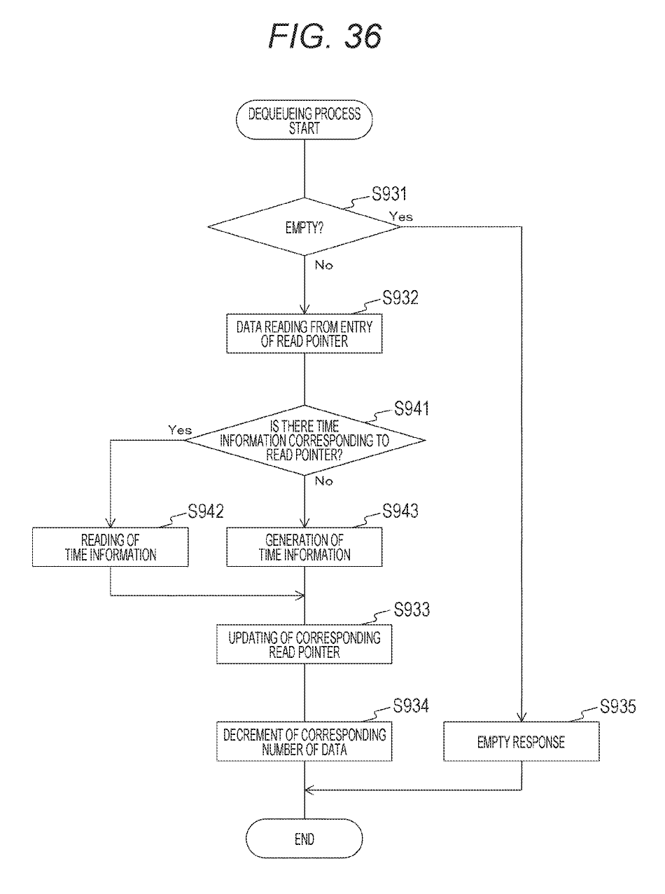

FIG. 36 is a flowchart illustrating an example of a dequeueing process in the variation of the second embodiment of the present technology. The dequeueing process of the second embodiment is different from that of the first embodiment in further executing steps S941, S942 and S943.

The read pointer control unit 232 reads the data in response to a read request (step S932) and determines whether the time information corresponding to the entry indicated by the read pointer is held in the FIFO data holding unit 220 (step S941). In a case where this is held (step S941: Yes), the read pointer control unit 232 reads the time information (step S942). On the other hand, in a case where this is not held (step S941: No), the read pointer control unit 232 generates the corresponding time information using equation 1 and the like (step S943). After step S942 or S943, the read pointer control unit 232 executes step S933 and subsequent steps.

In this manner, according to a second variation of the second embodiment of the present technology, since the FIFO memory 200 holds only the latest time information, the memory capacity may be reduced as compared to a case where the time information is held for each entry.

Meanwhile, the above-described embodiments describe an example of embodying the present technology, and there is a correspondence relationship between the matters in the embodiments and the matters specifying the invention in claims. Similarly, there is a correspondence relationship between the matters specifying the invention in claims and the matters in the embodiments of the present technology having the same names. However, the present technology is not limited to the embodiments and may be embodied with various variations of the embodiment without departing from the spirit thereof.

Also, the procedures described in the above-described embodiments may be considered as a method including a series of procedures and may be considered as a program for allowing a computer to execute the series of procedures and a recording medium which stores the program. A compact disc (CD), a MiniDisc (MD), a digital versatile disc (DVD), a memory card, a Blu-ray™ Disc and the like may be used, for example, as the recording medium.

Meanwhile, the effect described in this specification is illustrative only and is not limitative; there may also be another effect.

Meanwhile, the present technology may also have a following configuration.

(1) A first-in first-out control circuit including:

a write pointer control unit which, when there is a data writing request to a first-in first-out data holding unit provided with a plurality of entries in each of which data is held, writes data in an entry indicated by a write pointer out of the plurality of entries and updates the write pointer; and

a read pointer control unit which reads the data from the entry indicated by a read pointer corresponding to a read unit which requests data reading out of a plurality of read pointers associated with different read units and updates the corresponding read pointer.

(2) The first-in first-out control circuit according to (1) described above,

in which the write pointer control unit further writes current time in the first-in first-out data holding unit together with the data each time the data writing is requested.

(3) The first-in first-out control circuit according to (2) described above,

in which the data holding unit holds the time for each of the entries, and

the read pointer control unit further reads the time corresponding to the entry indicated by the read pointer from the first-in first-out data holding unit.

(4) The first-in first-out control circuit according to (2) described above,

in which the data holding unit holds only latest time out of the written times as the latest time, and

in a case where time corresponding to the entry indicated by the read pointer is not held, the read pointer control unite, generates the corresponding time from the latest time.

(5) The first-in first-out control circuit according to any one of (1) to (4) described above,

in which, when data overflows from the first-in first-out data holding unit, the write pointer control unit supplies a buffer full response without writing the data.

(6) The first-in first-out control circuit according to any one of (1) to (4) described above,

in which, when data overflows from the first-in first-out data holding unit, the write pointer control unit supplies a buffer full response, writes the data in the entry indicated by the write pointer, and updates the write pointer and the read pointer.

(7) The first-in first-out control circuit according to any one of (1) to (6) described above, further including:

a number-of-data information holding unit which holds number-of-data information indicating the number of the data which is not read by the read unit for each of the read units,

in which the write pointer control unit determines whether data overflows from the first-in first-out data holding unit on the basis of the number-of-data information, and

the read pointer control unit determines whether there is no data which may be read by the read unit on the basis of the number-of-data information corresponding to the read unit.

(8) The first-in first-out control circuit according to described above,

in which the read pointer control unit generates the read pointer from the number-of-data information corresponding to the read unit and the write pointer.

(9) The first-in first-out control circuit according to any one of (1) to (6) described above, further including:

an empty flag holding unit which holds an empty flag indicating whether there is no data which may be read by the read unit for each of the read units,

in which the write pointer control unit determines whether data overflows from the first-in first-out data holding unit on the basis of the empty flag corresponding to the read unit, the write pointer, and the corresponding read pointer, and

the read pointer control unit determines whether there is no data which may be read by the read unit on the basis of the empty flag corresponding to the read unit.

(10) The first-in first-out control circuit according to any one of (1) to (6) described above, further including:

a full flag holding unit which holds a full flag indicating whether data overflows from the first-in first-out data holding unit for each of the read units,

in which the write pointer control unit determines whether data overflows from the first-in first-out data holding unit on the basis of the full flag corresponding to the read unit, and

the read pointer control unit determines whether there is no data which may be read by the read unit on the basis of the full flag corresponding to the read unit, the write pointer, and the corresponding read pointer.

(11) The first-in first-out control circuit according to any one of (1) to (10) described above, further including:

a threshold holding unit which holds a predetermined threshold for each of the read units,

in which, when the number of the data which is not read by the read unit becomes larger than the predetermined threshold corresponding to the read unit, the read pointer control unit issues a request of interruption for a process on the data to the read unit.

(12) A storage device including:

a first-in first-out data holding unit provided with a plurality of entries in each of which data is held;

a write pointer control unit which, when there is a data writing request to the first-in first-out data holding unit, writes data in an entry indicated by a write pointer out of the plurality of entries and updates the write pointer; and

a read pointer control unit which reads the data from the entry indicated by a read pointer corresponding to a read unit which requests data reading out of a plurality of read pointers associated with different read units and updates the corresponding read pointer.

(13) The storage device according to (12) described above, further including:

a status management unit which, when notification of a status of the storage device is requested, generates the status.

(14) A method of controlling a first-in first-out control circuit, the method including:

a write pointer controlling procedure of, when there is a data writing request to a first-in first-out data holding unit provided with a plurality of entries in each of which data is held, writing data in an entry indicated by a write pointer out of the plurality of entries and updates the write pointer; and

a read pointer controlling procedure of reading the data from the entry indicated by a read pointer corresponding to a read unit which requests data reading out of a plurality of read pointers associated with different read units and updates the corresponding read pointer.

### REFERENCE SIGNS LIST

100 Information processing apparatus
110 Data generation unit
120 Data processing unit
130 Bus
140 Real time clock
200 FIFO memory
210 Input interface
211 Input/output interface
220 FIFO data holding unit
221 Buffer data holding area
222 Time information holding area
230 FIFO control circuit
231 Write pointer control unit
232 Read pointer control unit
233 Interruption notification unit
234 Status management unit
240 Management information holding unit
241 Pointer holding unit
242 Number-of-data information holding unit
243 Empty flag holding unit
244 Full flag holding part
245 Interruption threshold holding unit
250 Output interface

1. A first-in first-out control circuit comprising:
a write pointer control unit which, when there is a data writing request to a first-in first-out data holding unit provided with a plurality of entries in each of which data is held, writes data in an entry indicated by a write pointer out of the plurality of entries and updates the write pointer; and
a read pointer control unit which reads the data from the entry indicated by a read pointer corresponding to a read unit which requests data reading out of a plurality of read pointers associated with different read units and updates the corresponding read pointer.

2. The first-in first-out control circuit according to claim 1,
wherein the write pointer control unit further writes current time in the first-in first-out data holding unit together with the data each time the data writing is requested.

3. The first-in first-out control circuit according to claim 2,
wherein the data holding unit holds the time for each of the entries, and
the read pointer control unit further reads the time corresponding to the entry indicated by the read pointer from the first-in first-out data holding unit.

4. The first-in first-out control circuit according to claim 2,
wherein the data holding unit holds only latest time out of the written times as the latest time, and in a case where time corresponding to the entry indicated by the read pointer is not held, the read pointer control unite, generates the corresponding time from the latest time.

5. The first-in first-out control circuit according to claim 1,
wherein, when data overflows from the first-in first-out data holding unit, the write pointer control unit supplies a buffer full response without writing the data.

6. The first-in first-out control circuit according to claim 1,
wherein, when data overflows from the first-in first-out data holding unit, the write pointer control unit supplies a buffer full response, writes the data in the entry indicated by the write pointer, and updates the write pointer and the read pointer.

7. The first-in first-out control circuit according to claim 1, further comprising:
a number-of-data information holding unit which holds number-of-data information indicating the number of the data which is not read by the read unit for each of the read units,
wherein the write pointer control unit determines whether data overflows from the first-in first-out data holding unit on the basis of the number-of-data information, and
the read pointer control unit determines whether there is no data which may be read by the read unit on the basis of the number-of-data information corresponding to the read unit.

8. The first-in first-out control circuit according to claim. 7,
wherein the read pointer control unit generates the read pointer from the number-of-data information corresponding to the read unit and the write pointer.

9. The first-in first-out control circuit according to claim 1, further comprising:
an empty flag holding unit which holds an empty flag indicating whether there is no data which may be read by the read unit for each of the read units,
wherein the write pointer control unit determines whether data overflows from the first-in first-out data holding unit on the basis of the empty flag corresponding to the read unit, the write pointer, and the corresponding read pointer, and
the read pointer control unit determines whether there is no data which may be read by the read unit on the basis of the empty flag corresponding to the read unit.

10. The first-in first-out control circuit according to claim 1, further comprising:
a full flag holding unit which holds a full flag indicating whether data overflows from the first-in first-out data holding unit for each of the read units,
wherein the write pointer control unit determines whether data overflows from the first-in first-out data holding unit on the basis of the full flag corresponding to the read unit, and
the read pointer control unit determines whether there is no data which may be read by the read unit on the basis of the full flag corresponding to the read unit, the write pointer, and the corresponding read pointer.

11. The first-in first-out control circuit according to claim 1, further comprising:
a threshold holding unit which holds a predetermined threshold for each of the read units,
wherein, when the number of the data which is not read by the read unit becomes larger than the predetermined threshold corresponding to the read unit, the read pointer control unit issues a request of interruption for a process on the data to the read unit.

12. A storage device comprising:
a first-in first-out data holding unit provided with a plurality of entries in each of which data is held;
a write pointer control unit which, when there is a data writing request to the first-in first-out data holding unit, writes data in an entry indicated by a write pointer out of the plurality of entries and updates the write pointer; and
a read pointer control unit which reads the data from the entry indicated by a read pointer corresponding to a read unit which requests data reading out of a plurality of read pointers associated with different read units and updates the corresponding read pointer.

13. The storage device according to claim 12, further comprising:
a status management unit which, when notification of a status of the storage device is requested, generates the status.

14. A method of controlling a first-in first-out control circuit, the method comprising:
a write pointer controlling procedure of, when there is a data writing request to a first-in first-out data holding unit provided with a plurality f entries in each of which data is held, writing data in an entry indicated by a write pointer out of the plurality of entries and updates the write pointer; and
a read pointer controlling procedure of reading the data from the entry indicated by a read pointer corresponding to a read unit which requests data reading out of a plurality of read pointers associated with different read units and updates the corresponding read pointer.
